(19) United States
(12) Patent Application Publication
(10) Pub. No.: US 2013/0147439 A1
(43) Pub. Date: Jun. 13, 2013

(54) ELECTRODE, BATTERY, BATTERY PACK, ELECTRONIC APPARATUS, ELECTRIC VEHICLE, ELECTRICAL STORAGE APPARATUS AND ELECTRICITY SYSTEM

(71) Applicant: SONY CORPORATION, Tokyo (JP)

(72) Inventor: Hidetoshi Takahashi, Kanagawa (JP)

(73) Assignee: SONY CORPORATION, Tokyo (JP)

(21) Appl. No.: 13/689,079

(22) Filed: Nov. 29, 2012

(30) Foreign Application Priority Data
Dec. 8, 2011 (JP) 2011-269416

(51) Int. Cl. H01M 4/66; H02J 7/00

(52) U.S. Cl. CPC H01M 4/667; H02J 7/00
USPC 320/134; 429/211

(57) ABSTRACT

An electrode includes a current collector and an electrode layer provided on the current collector. The electrode layer includes first particles containing an active material and second particles harder than the current collector. The second particles are present at least at an interface between the current collector and the electrode layer.

### CROSS REFERENCES TO RELATED APPLICATIONS

The present application claims priority to Japanese Priority Patent Application JP 2011-269416 filed in the Japan Patent Office on Dec. 8, 2011, the entire content of which is hereby incorporated by reference.

### BACKGROUND

The present application relates to an electrode, a battery including the electrode, a battery pack including the battery, an electronic apparatus, an electric vehicle, an electrical storage apparatus and an electricity system. More specifically, the present application relates to an electrode including a current collector and an electrode layer.

In related art, an electrode including primary particles of an active material having a small particle size or secondary particles of the active material formed by aggregation of the primary particles may have a problem that an active material layer is easily peeled off from a current collector at the time of pressing. This problem is attributed to the fact that the active material as mentioned above has such a large specific surface area that allows a large amount of a binder to be absorbed in between the primary particles or in the secondary particles; and that as the active material crumbles at the time of pressing, the difference in coefficient of extension occurs between the active material and a substrate material.

For some active materials, it may be desirable to reduce the particle size of primary particles of the active material in order to improve the charge-discharge characteristics, so improvement of adhesion characteristics in the electrodes including such active materials is a technique of great importance.

Thus, in the past, a technique for improving adhesiveness between a current collector and an active material layer has been desired. For example, the publications of Japanese Patent No. 3997606 and No. 3482443 suggest as such kind of technique, a technique in which a binding agent is highly-concentrated in an interface between the current collector and the active material layer.

### SUMMARY

In view of the circumstances as described above, it is thus desirable to provide an electrode capable of improving adhesiveness between a current collector and an electrode layer, a battery including the electrode, a battery pack including the battery, an electronic apparatus, an electric vehicle, an electrical storage apparatus and an electricity system.

According to an embodiment of the present application, there is provided an electrode including a current collector and an electrode layer provided on the current collector. The electrode layer includes first particles containing an active material and second particles harder than the current collector. The second particles are present at least at an interface between the current collector and the electrode layer.

According to another embodiment of the present application, there is provided an electrode including a current collector and an electrode layer provided on the current collector. The electrode layer includes first particles containing an active material and second particles harder than the current collector. The second particles are provided embedded in the current collector.

According to other embodiments of the present application, there are provided a battery pack, an electronic apparatus, an electric vehicle, an electrical storage apparatus and an electricity system, each of the embodiments including a battery that has the electrode(s) according to at least one of the embodiments described above.

In the embodiments of the present application, since the second particles are harder than the current collector, the second particles are able to be provided embedded in the surface of the current collector. Hence, it becomes possible to suppress delamination between the current collector and the electrode layer at the interface.

As described above, according to the present application, it is possible to improve adhesiveness between a current collector and an electrode layer.

Additional features and advantages are described herein, and will be apparent from the following Detailed Description and the figures.

### BRIEF DESCRIPTION OF THE FIGURES

FIG. 1 is a cross-sectional view showing a configuration example of a non-aqueous electrolyte secondary battery according to a first embodiment of the present application;

FIG. 2 is an enlarged cross-sectional view showing a part of the spirally wound electrode body shown in FIG. 1;

FIG. 3A is a cross-sectional view showing a first configuration example of a positive electrode layer;

FIG. 3B is an enlarged cross-sectional view showing an interface between a positive electrode current collector and an adhesion layer;

FIG. 3C is a cross-sectional view showing a second configuration example of a positive electrode layer;

FIGS. 4A to 4C are diagrams for illustrating states of embedment of the second particles;

FIG. 5 is a cross-sectional view showing a configuration example of a non-aqueous electrolyte secondary battery according to a second embodiment of the present application;

FIG. 6A is a cross-sectional view showing a first configuration example of a negative electrode layer;

FIG. 6B is an enlarged cross-sectional view showing an interface between a negative electrode current collector and an adhesion layer;

FIG. 6C is a cross-sectional view showing a second configuration example of a negative electrode layer;

FIG. 7 is an exploded perspective view showing a configuration example of a non-aqueous electrolyte secondary battery according to a third embodiment of the present application;

FIG. 8 is a cross-sectional view of the spirally wound electrode body shown in FIG. 7, taken along line VIII-VIII;

FIG. 9 is a block diagram showing a configuration example of a battery pack according to a fourth embodiment of the present application;

FIG. 10 is a schematic view showing an application example of power storage system for houses, using a non-aqueous electrolyte secondary battery according to an embodiment of the present application;

FIG. 11 is a diagram showing schematically an example of configuration of a hybrid vehicle employing series-hybrid system in which an embodiment of the present application is applied;

FIG. 12A is a SEM image of a delaminated surface of positive electrode current collector in Comparative Example 1;

FIG. 12B is an enlarged SEM image showing a part of the SEM image in FIG. 12A;

FIG. 13A is a SEM image of a delaminated surface of positive electrode current collector in Comparative Example 4; and

FIG. 13B is an enlarged SEM image showing a part of the SEM image in FIG. 13A.

### DETAILED DESCRIPTION

Hereinafter, embodiments of the present application will be described with reference to the drawings. The descriptions will be made in the following order.

1. First embodiment (example of cylinder type battery provided with improved adhesiveness in positive electrode)

2. Second embodiment (example of cylinder type battery provided with improved adhesiveness in negative electrode)

3. Third embodiment (example of flat type battery provided with improved adhesiveness in positive electrode)

4. Fourth embodiment (example of battery pack)

5. Fifth embodiment (example of power storage system, etc.)

### 1. First Embodiment

[Configuration of Battery]

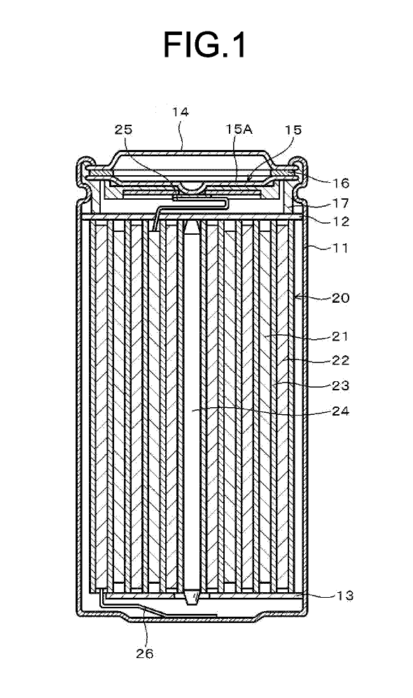

FIG. 1 is a cross-sectional view showing a configuration example of a non-aqueous electrolyte secondary battery according to a first embodiment of the present application. This non-aqueous electrolyte secondary battery shown as an example is a so-called “lithium-ion secondary battery” in which the capacity of a negative electrode is represented by capacitance component according to intercalating and deintercalating of lithium (Li) as a reactive electrode material. This non-aqueous electrolyte secondary battery is a so-called “cylinder type” battery, and has a spirally wound electrode body 20 having a pair of strips of a positive electrode 21 and a negative electrode 22 laminated and spirally wound with a separator 23 in between, provided inside a hollow and substantially cylinder-shaped battery can 11. The battery can 11 is made of iron (Fe) plated with nickel (Ni), for example. One end of the battery can 11 is closed and the other end is open. Inside the battery can 11, there are an electrolytic solution injected and a separator 23 impregnated with the electrolytic solution. A pair of insulating plates 12 and 13 is disposed each perpendicularly to the winding peripheral surface of the spirally wound electrode body 20 sandwiched between.

A battery cover 14, and a safety valve mechanism 15 and a positive temperature coefficient device (PTC device) 16 provided on the inner side of the battery cover 14 are caulked via a sealing gasket 17, to be attached at the open end of the battery can 11. Therefore, the inside of the battery can 11 is sealed. The battery cover 14 is made, for example, of the same material as the battery can 11. The safety valve mechanism 15 is electrically connected with the battery cover 14. The safety valve mechanism 15 is configured so that if the internal pressure reaches or exceeds a certain level due to internal short-circuit or heating from the outside or the like, a disc plate 15A would be inverted to cut off the electrical connection between the battery cover 14 and the spirally wound electrode body 20. The sealing gasket 17 is made of material such as insulating material, and its surface is coated with asphalt, for example.

In the center of the spirally wound electrode body 20, for example, a center pin 24 has been inserted. A positive electrode lead 25 made of material such as aluminum (Al) is connected to the positive electrode 21 of the spirally wound electrode body 20. A negative electrode lead 26 made of material such as nickel (Ni) is connected to the negative electrode 22 of the spirally wound electrode body 20. The positive electrode lead 25 is electrically connected with the battery cover 14 by being welded to the safety valve mechanism 15. The negative electrode lead 26 is electrically connected by welding to the battery can 11.

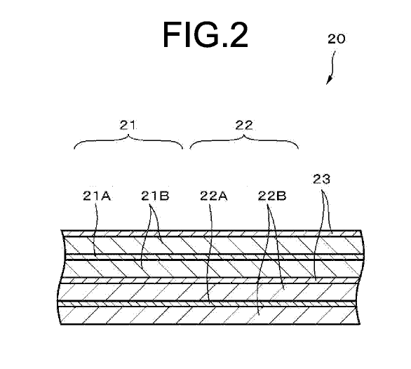

FIG. 2 is an enlarged cross-sectional view showing a part of the spirally wound electrode body 20 shown in FIG. 1. In the following, with reference to FIG. 2, descriptions for the positive electrode 21, negative electrode 22, the separator 23 and the electrolytic solution, which are included in the secondary battery, will be given in this order.

(Positive Electrode)

The positive electrode 21 includes a positive electrode current collector 21A and positive electrode layers (electrode layer) 21B provided on both sides of the positive electrode current collector 21A. In addition, although not shown in the drawing, the positive electrode 21 may be provided with the positive electrode layer 21B on only one side of the positive electrode current collector 21A.

(Positive Electrode Current Collector)

The positive electrode current collector 21A has metal as the main component, for example. Examples of the metal to be used include aluminum (Al), nickel (Ni), stainless steel and the like. Examples of possible shapes of the positive electrode current collector 21A include foil, plate-like, mesh form and the like.

(Positive Electrode Layer)

The positive electrode layer 21B includes first particles and second particles. The positive electrode layer 21B may include conducting agent such as graphite and binding agent if necessary. Examples of the binding agent include polyvinylidene fluoride (PVDF), polytetrafluoroethylene (PTFE), polyvinylidene fluoride-hexafluoropropylene copolymer, ethylene-propylene-diene terpolymer (EPDM), tetrafluoroethylene-hexafluoropropylene copolymer, silicon-acrylic copolymer and the like, which may be used either alone or in combination of two or more.

The second particles are present at least at an interface between the positive electrode current collector 21A and the positive electrode layer 21B. From the viewpoint of suppressing an increase of the second particles, the second particles may desirably be most abundantly present at the interface with the positive electrode current collector 21A or at the vicinity of the interface of in the positive electrode layer 21B. The second particles may further desirably be present only at the interface and the vicinity thereof. The second particles present at the interface may desirably be embedded in the positive electrode current collector 21A. By providing the second particles embedded as described above, it becomes possible to improve adhesiveness between the positive electrode current collector 21A and the positive electrode layer 21B. In addition, the second particles provided embedded as described above may also be only present in a partial area of the interface between the positive electrode current collector 21A and the positive electrode layer 21B. However, from the viewpoint of improving adhesiveness, the second particles may desirably be present over almost the entire interface.

(First Particles)

The first particles contain a positive electrode active material as the main component. The material to be used as the first particles may be one which is softer than the positive electrode current collector 21A for example. Even when the first particles are softer than the positive electrode current collector 21A as described above, it would be possible to improve adhesiveness between the positive electrode current collector 21A and the positive electrode layer 21B as long as the second particles are provided embedded in the surface of the positive electrode current collector 21A.

It may be determined as follows whether or not the first particles are softer than the positive electrode current collector 21A. First of all, slurry containing the first particles is coated on the positive electrode current collector 21A, then the slurry is cured by drying, and a layer containing the first particles is thus produced. Next, a sample electrode is prepared by pressing the layer containing the first particles. Then, a layer of the sample electrode is peeled off. In addition, in order to facilitate the peeling of the layer, the surface of the positive electrode current collector 21A may be subjected to a demolding process in advance. Further, before the peeling of the layer, the sample electrode may be immersed in a solvent to be subjected to a cleaning process by an ultrasonic cleaner.

Subsequently, a delaminated surface of the positive electrode current collector 21A from which the layer has been peeled off is photographed using a scanning electron microscope (SEM). Then from the photographed picture, whether or not the first particles have made irregularities to the surface of the positive electrode current collector 21A would be determined. If the first particles have made irregularities to the surface of the positive electrode current collector 21A, it can be determined that the first particles are harder than the positive electrode current collector 21A. Conversely, if the first particles have not made irregularities to the surface of the positive electrode current collector 21A, it can be determined that the first particles are softer than the positive electrode current collector 21A. Hereinafter, the determination method as described above will be referred to as “hardness determination method for the first particles”.

It may be determined as follows alternatively whether or not the first particles are softer than the positive electrode current collector 21A. First of all, the sample electrode which has been prepared as described above is cut out providing its cross-section by focused ion beam (FIB) processing, and subsequently, the cross-section is photographed using a SEM. Then from the photographed picture, whether or not the first particles have made irregularities to the surface of the positive electrode current collector 21A would be determined.

It should be noted that in the case where the first particles are primary particles, “hardness of the first particles” represents the hardness of the primary particles. In addition, in the case where the first particles are secondary particles, “hardness of the first particles” represents the hardness of the secondary particles.

Whether or not the first particles are softer than the positive electrode current collector 21A may be examined on the basis of criteria provided as follows. First of all, crushing stress of various species of the first particles having different hardness is measured using a microhardness tester. Then each species of the first particles whose crushing stress has been measured is examined its relative order of hardness compared to the positive electrode current collector 21A, using the aforementioned “hardness determination method for the first particles”. By matching the results obtained from the above, a calculation may be performed to predetermine how the crushing stress should be when the first particles are softer than the positive electrode current collector 21A. After this, whether or not the first particles are softer than the positive electrode current collector 21A is able to be estimated just by measuring crushing stress itself.

Examples of particles to be used as the first particles include primary particles and secondary particles, which may be used either alone or in combination of two or more. From the viewpoint of improving charge-discharge characteristics, an average diameter of the primary particles may desirably be small. Specifically, the average diameter may desirably be 5 μm or more and 100 μm or less. By taking the average diameter of 5 μm or more, it is possible to increase the crystallinity of the positive electrode active material. Besides, by taking the average diameter of 100 μm or less, a distance for lithium ion diffusion within each of the primary particles may be shortened, and thus it is possible to increase the ionic conductivity thereof. The secondary particles may desirably include those formed by aggregation of a plurality of the primary particles having such a small average diameter.

The secondary particles may also include those which have a core-shell structure having a core portion and a shell portion surrounding the core portion. The core-shell structure may be a structure in which the shell portion covers the core portion completely and may also be a structure in which the shell portion is covering a part of the core portion. In addition, some part of the primary particles of the shell portion may be present as forming a domain or the like in the core particles. Furthermore, a multilayer structure of three or more layers, having one or more layers in different composition from the core portion and the shell portion, between the core portion and the shell portion, may also be included therein.

Examples of possible shapes of the primary particles include spherical, ellipsoidal, acicular, plate-like, scale-like, tubular, wire-shaped, bar-like (rod-like), indeterminate form and the like, but not particularly limited thereto. The types of particles in the above-mentioned shapes may also be used in combination of two or more. The spherical shape as mentioned here includes in addition to the shape of a completely round sphere, for example, the shape in which a completely round sphere is slightly flattened or distorted, the shape in which a completely round sphere has irregularities formed on its surface, and the shape of the combination thereof. The ellipsoidal shape as mentioned here includes in addition to the shape of an exact ellipsoid, for example, the shape in which an exact ellipsoid is slightly flattened or distorted, the shape in which an exact ellipsoid has irregularities formed on its surface, and the shape of the combination thereof.

Examples of possible shapes of the secondary particles include spherical, ellipsoidal, acicular, plate-like, scale-like, tubular, wire-shaped, bar-like (rod-like), indeterminate form and the like, but not particularly limited thereto. The types of particles in the above-mentioned shapes may also be used in combination of two or more. The spherical shape as mentioned here includes in addition to the shape of a completely round sphere, for example, the shape in which a completely round sphere is slightly flattened or distorted, the shape in which a completely round sphere has irregularities formed on its surface, and the shape of the combination thereof. The ellipsoidal shape as mentioned here includes in addition to the shape of an exact ellipsoid, for example, the shape in which an exact ellipsoid is slightly flattened or distorted, the shape in which an exact ellipsoid has irregularities formed on its surface, and the shape of the combination thereof.

The positive electrode active material contained in the first particles is, for example, one or more kinds of positive electrode materials capable of intercalating and deintercalating lithium. Materials suitable for the positive electrode material capable of intercalating and deintercalating lithium may include, for example, a lithium-containing compound such as lithium oxide, lithium phosphate, lithium sulfide, and lithium-containing intercalation compounds, and a mixture of two or more of these compounds may also be used. For achieving high energy density, the lithium-containing compound that contains lithium, transition metal element, and oxygen (O) may be desirable. In particular, the lithium-containing compound that contains at least one kind of transition metal element selected from the group consisting of cobalt (Co), nickel (Ni), manganese (Mn) and iron (Fe) may be more desirable. Examples of such lithium-containing compounds include lithium composite oxide having a layered rock salt-type structure represented by either of the following formulae (1), (2) and (3), lithium composite oxide having a spinel-type structure represented by the following formula (4), lithium composite phosphate having an olivine-type structure represented by either of the following formulae (5) and (6), and the like. Specific examples thereof include LiNi_{0.50}Co_{0.20}Mn_{0.30}O₂, LiₐCoO₂ (a≈1), Li_{b}NiO₂ (b≈1), Li_{c1}Ni_{c2}Co_{1-c2}O₂ (c1≈1 0<c2<1), Li_{d}Mn₂O₄ (d≈1), LiₑFePO₄ (e≈1) and the like.

When a lithium composite phosphate having an olivine-type structure is to be used as the lithium-containing compound, a lithium composite phosphate that contains manganese (Mn) may be desirable. This is because it makes possible to improve the discharge capacity.

Li_{f}Mn_{(1-g-h)}Ni_{g}M1ₕO₍₂₋ⱼ₎Fₖ (1)

(In this formula (1), M1 indicates at least one kind of element selected from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr) and tungsten (W). In the formula, f, g, h, j and k are values within the range defined as 0.8≦f≦1.2, 0<g<0.5, 0≦h≦0.5, g+h<1, −0.1≦j≦0.2 and 0≦k≦0.1. It should be noted that the composition of lithium varies depending on the charging and discharging state, and the value off indicates the value in the fully-discharged state.)

LiₘNi₍₁₋ₙ₎M2ₙO₍₂₋ₚ)F_{q} (2)

(In this formula (2), M2 indicates at least one kind of element selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). In the formula, m, n, p and q are values within the range defined as 0.8≦m≦1.2, 0.005≦n≦0.5, −0.1≦p≦0.2 and 0≦q≦0.1. It should be noted that the composition of lithium varies depending on the charging and discharging state, and the value of m indicates the value in the fully-discharged state.)

LiᵣCo₍₁₋ₛ₎M3ₛO₍₂₋ₜ₎Fᵤ (3)

(In this formula (3), M3 indicates at least one kind of element selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). In the formula, r, s, t and u are values within the range defined as 0.8≦r≦1.2, 0≦s<0.5, −0.1≦t≦0.2 and 0≦u≦0.1. It should be noted that the composition of lithium varies depending on the charging and discharging state, and the value of r indicates the value in the fully-discharged state.)

LiᵥMn_{2-w}M4_{w}OₓF_{y} (4)

(In this formula (4), M4 indicates at least one kind of element selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). In the formula, v, w, x and y are values within the range defined as 0.9≦v≦1.1, 0≦w<0.6, 3.7≦x≦4.1 and 0≦y≦0.1. It should be noted that the composition of lithium varies depending on the charging and discharging state, and the value of v indicates the value in the fully-discharged state.)

Li_{z}M5PO₄ (5)

(In this formula (5), M5 indicates at least one kind of element selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W) and zirconium (Zr). In the formula, z is a value within the range defined as 0.9≦z≦1.1. It should be noted that the composition of lithium varies depending on the charging and discharging state, and the value of z indicates the value in the fully-discharged state.)

LiₐMn_{b}M6_{(1-b)}PO₄ (6)

(In this formula (6), M6 indicates at least one kind of element selected from the group consisting of cobalt (Co), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W) and zirconium (Zr). In the formula, a and b are values within the range defined as 0.9<a<1.1 and 0<b<1. It should be noted that the composition of lithium varies depending on the charging and discharging state, and the value of a indicates the value in the fully-discharged state.)

There are other examples of materials as the positive electrode material capable of intercalating and deintercalating lithium, and such other examples include inorganic compounds that do not contain lithium such as MnO₂, V₂O₅, V₆O₁₃, NiS and MoS.

(Second Particles)

Particles to be used as the second particles include those which are harder than the positive electrode current collector 21A. By using hard particles as the second particles as described above, it becomes possible to embed the second particles to be provided into the surface of the positive electrode current collector 21A in the press process which will be described later. Therefore, it becomes possible to improve adhesiveness between the positive electrode current collector 21A and the positive electrode layer 21B.

It may be determined as follows whether or not the second particles are harder than the positive electrode current collector 21A. First of all, slurry containing the second particles is coated on the positive electrode current collector 21A, then the slurry is cured by drying, and a layer containing the second particles is thus produced. Next, a sample electrode is prepared by pressing the layer containing the second particles. Then, a layer of the sample electrode is peeled off. In addition, in order to facilitate the peeling of the layer, the surface of the positive electrode current collector 21A may be subjected to a demolding process in advance. Further, before the peeling of the layer, the sample electrode may be immersed in a solvent to be subjected to a cleaning process by an ultrasonic cleaner.

Subsequently, a delaminated surface of the positive electrode current collector 21A from which the layer has been peeled off is photographed using a SEM. Then from the photographed picture, whether or not the second particles have made irregularities to the surface of the positive electrode current collector 21A would be determined. If the second particles have made irregularities to the surface of the positive electrode current collector 21A, it can be determined that the second particles are harder than the positive electrode current collector 21A. Conversely, if the second particles have not made irregularities to the surface of the positive electrode current collector 21A, it can be determined that the second particles are softer than the positive electrode current collector 21A. Hereinafter, the determination method as described above will be referred to as “hardness determination method for the second particles”.

It may be determined as follows alternatively whether or not the second particles are harder than the positive electrode current collector 21A. First of all, the sample electrode which has been prepared as described above is cut out providing its cross-section by FIB processing, and subsequently, the cross-section is photographed using a SEM. Then from the photographed picture, whether or not the second particles have made irregularities to the surface of the positive electrode current collector 21A would be determined.

It should be noted that in the case where the second particles are primary particles, “hardness of the second particles” represents the hardness of the primary particles. In addition, in the case where the second particles are secondary particles, “hardness of the second particles” represents the hardness of the secondary particles.

Whether or not the second particles are harder than the positive electrode current collector 21A may be examined on the basis of criteria provided as follows. First of all, crushing stress of various species of the second particles having different hardness is measured using a microhardness tester. Then each species of the second particles whose crushing stress has been measured is examined its relative order of hardness compared to the positive electrode current collector 21A, using the aforementioned “hardness determination method for the second particles”. By matching the results obtained from the above, a calculation may be performed to predetermine how the crushing stress should be when the second particles are harder than the positive electrode current collector 21A. After this, whether or not the second particles are harder than the positive electrode current collector 21A is able to be estimated just by measuring crushing stress itself.

When provided that hardness or degree of hardness of the positive electrode current collector 21A is H_{A}, and hardness or degree of hardness of the second particles is H_{C}, the values of hardness or degree of hardness H_{A} and H_{C} satisfy a relationship of H_{A}<H_{C}. By satisfying such a relationship, it becomes possible to embed the second particles into the surface of the positive electrode current collector 21A in the press process which will be described later, and allow an anchor effect to be expressed. Therefore, it becomes possible to improve adhesiveness between the positive electrode current collector 21A and the positive electrode layer 21B.

When provided that hardness or degree of hardness of the positive electrode current collector 21A is H_{A}, hardness or degree of hardness of the second particles is H_{B}, and hardness or degree of hardness of the second particles is H_{C}, the values desirably may satisfy a relationship of H_{B}<H_{A}<H_{C}. By satisfying such a relationship, even when the first particles containing the positive electrode active material are softer than the positive electrode current collector 21A, by the expression of the anchor effect due to the second particles, it would be possible to improve adhesiveness between the positive electrode current collector 21A and the positive electrode layer 21B.

At the interface between the positive electrode current collector 21A and the positive electrode layer 21B, content of the second particles may desirably be 50% by mass or more and 100% by mass or less of the total amount of the first particles and the second particles. When the content is 50% by mass or more, even when the first particles are softer than the positive electrode current collector 21A, it would be made possible to obtain very good adhesiveness.

The content of the second particles at the interface may be determined in the following manner.

First of all, the positive electrode 21 is peeled at the interface between the positive electrode current collector 21A and the positive electrode layer 21B. In order to facilitate the peeling, the positive electrode 21 may be immersed in a solvent to be subjected to a cleaning process by an ultrasonic cleaner before the interfacial peeling. Next, a delaminated surface of the positive electrode layer 21B which has been peeled off is photographed using a scanning electron microscope (SEM), so that a SEM picture is obtained, and the composition of particles that are present at the delaminated surface is analyzed. Then, on the basis of the photographed SEM picture and the result of the composition analysis, the particles that are present at the delaminated surface is classified into the first and the second particles, and the content of the second particles would be determined based on the total amount of the first particles and the second particles.

An average diameter of the second particles may desirably be in the range of 0.5 μm or more and 15 μm or less. By taking the average diameter of the second particles of 0.5 μm or more, the anchor effect due to the second particles may be sufficiently expressed. Besides, by taking the average diameter of the second particles of 15 μm or less, it would be easier to make irregularities to the positive electrode current collector 21A, the number of the irregularities increased, and thus the anchor effect may be sufficiently expressed.

Examples of particles to be used as the second particles include primary particles and secondary particles, which may be used either alone or in combination of two or more. Examples of particle morphology of the second particles may include the same ones and different ones with the first particles. From the viewpoint of improving charge-discharge characteristics, an average diameter of the primary particles may desirably be small. Specifically, the average diameter may desirably be 5 μm or more and 100 μm or less. By taking the average diameter of 5 μm or more, it is possible to increase the crystallinity of the positive electrode active material. Besides, by taking the average diameter of 100 μm or less, a distance for lithium ion diffusion within each of the primary particles may be shortened, and thus it is possible to increase the ionic conductivity thereof. The secondary particles may desirably include those formed by aggregation of a plurality of the primary particles having such a small average diameter.

The secondary particles may also include those which have a core-shell structure having a core portion and a shell portion surrounding the core portion. The core-shell structure may be a structure in which the shell portion covers the core portion completely and may also be a structure in which the shell portion is covering a part of the core portion. In addition, some part of the primary particles of the shell portion may be present as forming a domain or the like in the core particles. Furthermore, a multilayer structure of three or more layers, having one or more layers in different composition from the core portion and the shell portion, between the core portion and the shell portion, may also be included therein.

Examples of possible shapes of the primary particles include spherical, ellipsoidal, acicular, plate-like, scale-like, tubular, wire-shaped, bar-like (rod-like), indeterminate form and the like, but not particularly limited thereto. The types of particles in the above-mentioned shapes may also be used in combination of two or more. The spherical shape as mentioned here includes in addition to the shape of a completely round sphere, for example, the shape in which a completely round sphere is slightly flattened or distorted, the shape in which a completely round sphere has irregularities formed on its surface, and the shape of the combination thereof. The ellipsoidal shape as mentioned here includes in addition to the shape of an exact ellipsoid, for example, the shape in which an exact ellipsoid is slightly flattened or distorted, the shape in which an exact ellipsoid has irregularities formed on its surface, and the shape of the combination thereof.

Examples of possible shapes of the secondary particles include spherical, ellipsoidal, acicular, plate-like, scale-like, tubular, wire-shaped, bar-like (rod-like), indeterminate form and the like, but not particularly limited thereto. The types of particles in the above-mentioned shapes may also be used in combination of two or more. The spherical shape as mentioned here includes in addition to the shape of a completely round sphere, for example, the shape in which a completely round sphere is slightly flattened or distorted, the shape in which a completely round sphere has irregularities formed on its surface, and the shape of the combination thereof. The ellipsoidal shape as mentioned here includes in addition to the shape of an exact ellipsoid, for example, the shape in which an exact ellipsoid is slightly flattened or distorted, the shape in which an exact ellipsoid has irregularities formed on its surface, and the shape of the combination thereof.

There may be used, at least one kind selected from the group consisting of positive electrode active material particles, conductive particles and nonconductive particles, for example, as the second particles. From the viewpoint of suppressing an increase in the interface resistance between the positive electrode current collector 21A and the positive electrode layer 21B, the particles to be used as the second particles may desirably be, at least one kind selected from the group consisting of the positive electrode active material particles and the conductive particles. From the viewpoint of suppressing an increase in the interface resistance between the positive electrode current collector 21A and the positive electrode layer 21B, and, suppressing a decrease in the battery capacity due to that the second particles are included in the positive electrode layer 21B, the particles to be used as the second particles may desirably be the positive electrode active material particles.

From the viewpoint of improving electronic and ionic conductivity, particles to be used as the positive electrode active material particles may desirably be those which are coated with carbon. When the lithium composite phosphate having the olivine-type structure represented by formula (5) or (6) is to be used as the positive electrode active material particles, the positive electrode active material particles which are coated with carbon may be particularly desirably used.

Although the positive electrode active material particles are particles which have conductivity in themselves, herein, “the positive electrode active material particles” should not necessarily be included in “the conductive particles”, and the two terms are defined as separate terms.

The positive electrode active material particles are, for example, particles which have conductivity and capability of intercalating and deintercalating lithium, and whose main component is a positive electrode active material. The positive electrode active material is, for example, one or more kinds of positive electrode materials capable of intercalating and deintercalating lithium. Examples of possible materials to be used as the positive electrode material capable of intercalating and deintercalating lithium may include those which have been listed as the positive electrode material for the first particles as described above.

Examples of the positive electrode active material to be used as the second particles may include the same ones and different ones, with those of the positive electrode active material for the first particles. When a lithium composite phosphate having an olivine-type structure is to be used as the positive electrode active material for the second particles, a lithium composite phosphate that contains manganese (Mn) may be desirable. Specifically, the lithium composite phosphate may desirably be one having the olivine-type structure represented by formula (6). This is because it makes possible to improve the discharge capacity. The value of b in formula (6) may desirably fall within the range of 0<b≦0.25. By taking the value within this range, it may tend to increase the hardness of the second particles.

When the lithium composite phosphates having the olivine-type structure represented by formula (6) are to be used as the first particles and the second particles, the value of b regarding the first particles may desirably fall within the range of 0.25<b<1, and the value of b regarding the second particles may desirably fall within the range of 0<b≦0.25. By taking the value of b within the range of 0.25<b<1 in the first particles, it may tend to increase the voltage during discharge and hence the energy density. Besides, by taking the value of b within the range of 0<b≦0.25 in the second particles, it may tend to increase the hardness of the second particles.

The conductive particles are, for example, particles which have electrical conductivity, whose main component is a conductive material. Particles to be used as the conductive particles may also be those in which the nonconductive particles are coated with the conductive material. There may be used, at least one kind selected from the group consisting of metal, metal oxide and carbon, for example, as the conductive material.

Examples of the metal include silver (Ag), aluminum (Al), gold (Au), platinum (Pt), palladium (Pd), nickel (Ni), chromium (Cr), niobium (Nb), tungsten (W), molybdenum (Mo), titanium (Ti), copper (Cu), neodymium (Nd) and the like, as simple substances or alloys containing at least one kind of metal thereof.

Examples of the metal oxide having electrical conductivity include binary compounds such as tin oxide (SnO₂), indium oxide (InO₂), zinc oxide (ZnO) and cadmium oxide (CdO), ternary compounds which contain at least one of the constituent elements of the binary compounds selected from tin (Sn), indium (In), zinc (Zn) and cadmium (Cd), and multicomponent (composite) oxide. Specific examples of the metal oxide having electrical conductivity include indium tin oxide (ITO), zinc oxide (ZnO), aluminum-doped zinc oxide (AZO (Al₂O₃—ZnO)), fluorine-doped tin oxide (FTO), tin oxide (SnO₂), gallium-doped zinc oxide (GZO) and indium zinc oxide (IZO (In₂O₃—ZnO)). In particular, from the viewpoint of high reliability and low resistivity, indium tin oxide (ITO) may be desirable.

There may be used, at least one kind selected from the group consisting of carbon black, carbon fiber, fullerene, graphene, carbon nanotube, carbon micro-coil, nanohorn and the like, for example, as the carbon. From the viewpoint of high hardness, the carbon to be used may desirably be graphene, superhard phase composed of single-wall carbon nanotubes (SP-SWNT, SP-SWCNT) or the like.

An average diameter of the conductive particles may desirably be in the range of 0.5 μm or more and 15 μm or less. By taking the average diameter of the conductive particles of 0.5 μm or more, it is possible to obtain very good adhesiveness. Besides, by taking the average diameter of the conductive particles of 15 μm or less, it would be easier to make irregularities to the positive electrode current collector 21A, the number of the irregularities increased, and thus it is possible to obtain very good adhesiveness.

The nonconductive particles are, for example, ceramic particles with little or no electrical conductivity, whose main component is a nonconductive material, which may be using ceramic particles of a single species or a mixture of ceramic particles of two or more species. Examples of the nonconductive material include ceramics such as metal oxide, metal nitride and metal carbide, which may be used either alone or in mixture of two or more. Examples of these ceramics to be used include alumina (Al₂O₃), silica (SiO₂), zirconia (ZrO₂), magnesia (MgO), titania (TiO₂), silicon nitride (Si₃N₄), silicon carbide (SiC), titanium carbide (TiC), titanium carbonitride (TiCN) and the like.

(Configuration of Positive Electrode Layer)

The positive electrode layer 21B has for example, a single layer structure or a multilayer structure of laminated two or more layers. In addition, the positive electrode layer 21B provided on one side of the positive electrode current collector 21A and the positive electrode layer 21B provided on the other side thereof may have different structures from each other.

When the positive electrode layer 21B has the multilayer structure, among the laminated layers, a layer adjacent to the positive electrode current collector 21A may desirably contain the second particles that are harder than the positive electrode current collector 21A.

When the positive electrode layer 21B has the single layer structure, the second particles have a distribution which varies along the thickness direction of the positive electrode layer 21B, for example. The distribution that increases toward a side at the interface between the positive electrode current collector 21A and the positive electrode layer 21B, from the surface opposite to the interface of the positive electrode layer 21B, and becomes the highest at the vicinity of the interface may be desirable. The variation in the distribution of the second particles may be continuous or discontinuous variation, for example. Examples of the distribution which varies discontinuously include a stepwise distribution.

In the following, descriptions for a configuration example of the positive electrode layer 21B having the multilayer structure (hereinafter, referred to as “first configuration example of positive electrode layer”) and a configuration example of the positive electrode layer 21B having the single layer structure (hereinafter, referred to as “second configuration example of positive electrode layer”) will be given in this order.

(First Configuration Example of Positive Electrode Layer)

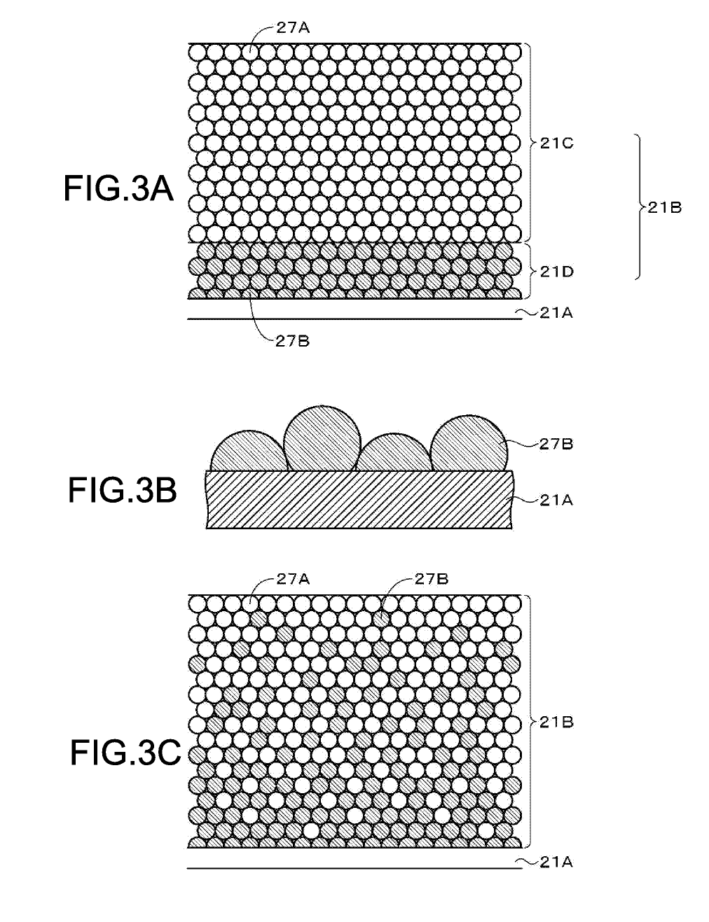

FIG. 3A is a cross-sectional view showing a first configuration example of the positive electrode layer shown in FIG. 2. As shown in FIG. 3A, the positive electrode layer 21B of the first configuration example includes, a positive electrode active material layer 21C, provided on a surface of the positive electrode current collector 21A, and an adhesion layer 21D, provided in between the surface of the positive electrode current collector 21A and a surface of the positive electrode active material layer 21C.

The positive electrode active material layer 21C includes, first particles 27A containing the positive electrode active material as their main component, for example. The positive electrode active material layer 21C may further include the conducting agent such as graphite and the binding agent such as polyvinylidene fluoride if necessary.

The adhesion layer 21D includes, second particles 27B harder than the positive electrode current collector 21A, for example. The adhesion layer 21D may further include the conducting agent such as graphite and the binding agent such as polyvinylidene fluoride if necessary.

As described above, there may be used, at least one kind selected from the group consisting of the positive electrode active material particles, the conductive particles and the nonconductive particles, for example, as the second particles. From the viewpoint of suppressing an increase in the interface resistance between the positive electrode current collector 21A and the positive electrode active material layer 21C due to the providing of the adhesion layer 21D, the particles to be used as the second particles may desirably be, at least one kind selected from the group consisting of the positive electrode active material particles and the conductive particles. From the viewpoint of suppressing an increase in the interface resistance between the positive electrode current collector 21A and the positive electrode active material layer 21C due to the providing of the adhesion layer 21D, and, suppressing a decrease in the battery capacity due to the providing of the adhesion layer 21D, the particles to be used as the second particles may desirably be the positive electrode active material particles.

The adhesion layer 21D may further include third particles softer than the positive electrode current collector 21A. In such a configuration, from the viewpoint of suppressing a decrease in the amount of active material per unit volume of the positive electrode layer 21B, it may be desirable that the both of the second particles 27B and the third particles contain the positive electrode active materials as their main components. When the lithium composite phosphate having the olivine-type structure is to be used as the positive electrode active material for the second particles 27B and the third particles, the lithium composite phosphate that contains manganese (Mn) may be desirable with regard to the third particles. This is because it makes possible to improve the energy density compared to the case of using LiFePO₄, or the like.

Content of the second particles may desirably be 50% by mass or more but less than 100% by mass of the total amount of the second particles and the third particles. When the content is 50% by mass or more, even when the third particles are softer than the positive electrode current collector 21A, it would be made possible to obtain very good adhesiveness.

The content of the second particles in the adhesion layer 21D may be determined in the following manner.

First of all, the positive electrode 21 is peeled at the interface between the positive electrode current collector 21A and the adhesion layer 21D. In order to facilitate the peeling, the positive electrode 21 may be immersed in a solvent to be subjected to a cleaning process by an ultrasonic cleaner before the interfacial peeling. Next, a delaminated surface of the adhesion layer 21D which has been peeled off is photographed using a scanning electron microscope (SEM), so that a SEM picture is obtained, and the composition of particles that are present at the delaminated surface is analyzed. Then, on the basis of the photographed SEM picture and the result of the composition analysis, the particles that are present at the delaminated surface is classified into the second and the third particles, and the content of the second particles would be determined based on the total amount of the first particles and the second particles.

FIG. 3B is an enlarged cross-sectional view showing an interface between the positive electrode current collector and the adhesion layer. As shown in FIG. 3B, a part of surfaces of the second particles 27B present at the interface between the positive electrode current collector 21A and the adhesion layer 21D may desirably be provided embedded in the positive electrode current collector 21A. The entire surface of the second particles 27B present at the vicinity of the interface between the positive electrode current collector 21A and the adhesion layer 21D may also be provided embedded in the positive electrode current collector 21A.

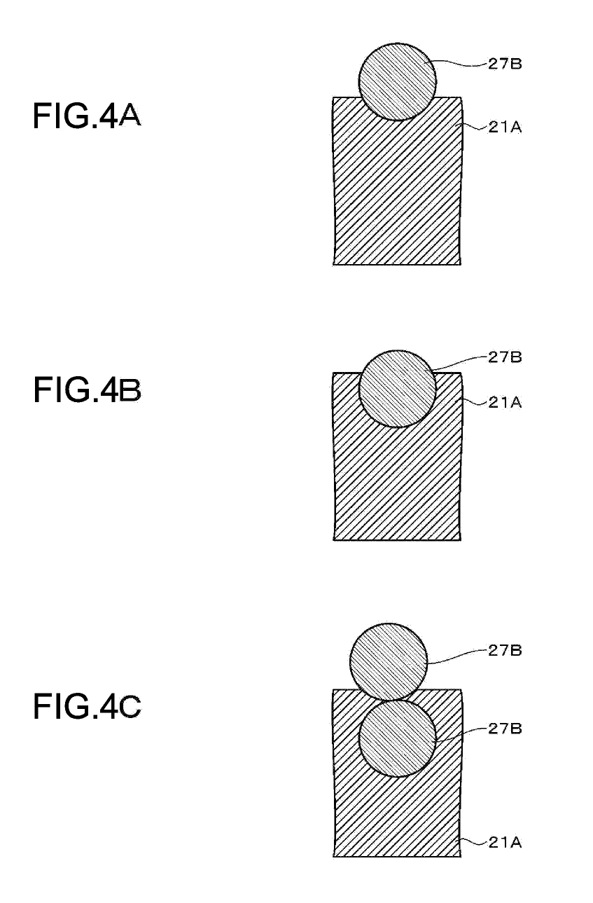

FIGS. 4A to 4C are diagrams for illustrating states of the embedment of the second particles. When a part of surfaces of the second particles 27B is embedded in the surface of the positive electrode current collector 21A, a state of its embedment is not particularly limited. Although both the state in which a part less than half of the second particle 27B is embedded in the surface of the positive electrode current collector 21A (as shown in FIG. 4A) and the state in which a part more than half of the second particle 27B is embedded in the surface of the positive electrode current collector 21A (as shown in FIG. 4B) may be possible, from the viewpoint of improving the anchor effect, the state of the latter may be desirable.

As shown in FIG. 4C, when the entire surface of the second particle 27B is embedded in the surface of the positive electrode current collector 21A, it may be desirable that the embedded second particles 27B be bonded to other second particle 27B that is included in the adhesion layer 21D by the binding agent, sintering or the like. This is because such a configuration would allow the expression of the anchor effect, even when the entire surface of the second particle 27B is embedded in the surface of the positive electrode current collector 21A.

(Second Configuration Example of Positive Electrode Layer)

FIG. 3C is a cross-sectional view showing a second configuration example of the positive electrode layer shown in FIG. 2. The positive electrode layer 21B of the second configuration example is a positive electrode active material layer including the both of the first particles 27A and the second particles 27B. The positive electrode layer 21B may further include the conducting agent such as graphite and the binding agent such as polyvinylidene fluoride if necessary.

The first particles 27A and the second particles 27B have a distribution which varies along the thickness direction of the positive electrode layer 21B (in a direction from the surface on the side facing the negative electrode 22 across the separator 23, of the positive electrode layer 21B, toward the interface between the positive electrode current collector 21A and the positive electrode layer 21B). Whereas the distribution of the first particles 27A may be the lowest at the side at the interface between the positive electrode current collector 21A and the positive electrode layer 21B, the distribution of the second particles 27B being the highest at the side at the interface may be desirable. More specifically, for example, the distribution of the first particles 27A may gradually vary along the thickness direction of the positive electrode layer 21B in such a way that the distribution becomes the lowest at the side at the interface between the positive electrode current collector 21A and the positive electrode layer 21B. On the other hand, the distribution of the second particles 27B may gradually vary along the thickness direction of the positive electrode layer 21B in such a way that the distribution becomes the highest at the side at the interface between the positive electrode current collector 21A and the positive electrode layer 21B.

(Negative Electrode)

The negative electrode 22 includes a negative electrode current collector 22A and negative electrode active material layers 22B provided on both sides of the negative electrode current collector 22A, for example. In addition, although not shown in the drawing, the negative electrode 22 may be provided with the negative electrode active material layers 22B on only one side of the negative electrode current collector 22A.

The negative electrode current collector 22A has metal as the main component, for example. Examples of the metal to be used include copper (Cu), stainless steel and the like. Examples of possible shapes of the negative electrode current collector 22A include foil, plate-like, mesh form and the like.

The negative electrode active material layer 22B is configured including one or more kinds of negative electrode materials capable of intercalating and deintercalating lithium as a negative electrode active material. The configuration of the negative electrode active material layer 22B may further include the binding agent similar to that in the positive electrode active material layer 21C if necessary.

In addition, in this secondary battery, the electrochemical equivalent of the negative electrode material capable of intercalating and deintercalating lithium is made larger than the electrochemical equivalent of the positive electrode 21, thereby preventing unintentional deposition of lithium metal on the negative electrode 22 during charging.

Examples of the negative electrode materials capable of intercalating and deintercalating lithium include carbon materials such as non-graphitizable carbon, graphitizable carbon, graphite, pyrolytic carbons, cokes, glassy carbons, baked organic polymer compounds, carbon fiber and activated carbon. Among such materials, the cokes may include pitch coke, needle coke and petroleum coke, for example. The baked organic polymer compounds are materials in which a polymeric material such as phenolic resin and furan resin is baked at appropriate temperatures and carbonized. Some of the baked organic polymer compounds can also be classified as non-graphitizable carbon, or graphitizable carbon. Further, examples of the polymeric materials include polyacetylene and polypyrrole.

These carbon materials may be desirable because the possible changes in crystal structure of such materials in charging or discharging may be very small, and it makes possible to obtain high charge-discharge capacity and good cycle characteristics. In particular, graphite may be desirable because its electrochemical equivalent is large, it makes possible to obtain high energy density. In addition, non-graphitizable carbon may be desirable because it makes possible to obtain good characteristics. Furthermore, the carbon material whose charge and discharge potential is low, specifically, one with charge and discharge potential close to that of lithium metal, may be desirable because it makes possible to easily realize high energy density of the battery.

Examples of the negative electrode materials capable of intercalating and deintercalating lithium further include material that is capable of intercalating and deintercalating lithium and contains at least one kind of metal element or semimetal element as a constituent element. This is because it makes possible to obtain high energy density when such material is used. In particular, it may be further desirable to use such material with the carbon material because it makes possible to obtain high energy density and good cycle characteristics. Such negative electrode material may be in any form of either or both of metal elements and semimetal elements, such as a single substance, an alloy, a compound, and a material that includes one or more of these forms at least in a portion thereof. It should be noted that the alloys, regarding the embodiments of the present application, include those containing two or more kinds of metal elements, and also those containing one or more kinds of metal elements and one or more kinds of semimetal elements. Further, the alloy may also contain non-metal elements. Possible structures of the alloy include a solid solution, a eutectic crystal (eutectic mixture), an intermetallic compound, and coexistence of two or more thereof.

Examples of the metal elements and the semimetal elements in the configuration of the negative electrode material include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt). These may be crystalline or amorphous.

Among such examples, as the negative electrode material, those containing as a constituent element a metal element or a semi-metal element belonging to the group 4B in the short form of the periodic table may be desirable, and those containing as a constituent element at least one of silicon (Si) and tin (Sn) may be particularly desirable. This is because silicon (Si) and tin (Sn) have large capability of intercalating and deintercalating lithium (Li), and it makes possible to obtain high energy density.

Examples of the alloy of tin (Sn) include an alloy containing, as its second constituent element other than tin (Sn), at least one kind of element selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of the alloy of silicon (Si) include an alloy containing, as its second constituent element other than silicon (Si), at least one kind of element selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of the compound of tin (Sn) or the compound of silicon (Si) include a compound that contains either or both of oxygen (O) and carbon (C). Such compound may also contain, in addition to tin (Sn) or silicon (Si), any of the second constituent elements described above.

Further examples of the negative electrode materials capable of intercalating and deintercalating lithium include other metal compounds and polymeric materials. Examples of the other metal compounds include oxide such as MnO₂, V₂O₅ and V₆O₁₃, sulfide such as NiS and MoS, and lithium nitride such as LiN₃. Examples of the polymeric materials include polyacetylene, polyaniline, polypyrrole and the like.

(Separator)

The separator 23 is configured to separate the positive electrode 21 and the negative electrode 22, preventing the possible electric short-circuiting due to a contact of the two electrodes while allowing the passage of lithium-ion. Examples of the separator 23 include a porous film, made of synthetic resin such as polytetrafluoroethylene, polypropylene and polyethylene, and a porous film made of ceramic. Those may be used in a single layer or by laminating a plurality of the layers thereof. As the separator 23, a porous film made of polyolefin may be particularly desirable. This is because it has superior effect on preventing a short circuit and is capable of improving safety of the battery by the shutdown effect. In addition, those in which a layer of porous resin such as polyvinylidene fluoride (PVDF) and polytetrafluoroethylene (PTFE) has been formed on a microporous membrane such as polyolefin may be used as the separator 23.

(Electrolytic Solution)

The separator 23 is impregnated with an electrolytic solution that is a liquid electrolyte. This electrolytic solution contains a solvent and an electrolyte salt dissolved in this solvent.

As the solvent, at least one of cyclic carbonates such as ethylene carbonate and propylene carbonate may be used, and at least one of ethylene carbonate and propylene carbonate, particularly a mixture of the both thereof, may be desirable. This is because it makes possible to improve the cycle characteristics.

Further, as the solvent, in addition to the cyclic carbonates as described above, the use by mixing, of at least one of chain carbonates such as diethyl carbonate, dimethyl carbonate, ethyl methyl carbonate and methyl propyl carbonate, may be desirable. This is because it makes possible to obtain high ionic conductivity.

Furthermore, it may be desirable that at least one of 2,4-difluoroanisole and vinylene carbonate be contained as the solvent. This is because 2,4-difluoroanisole is able to improve the discharge capacity, and vinylene carbonate is able to improve the cycle characteristics. Accordingly, these may be desirably mixed to improve the discharge capacity and the cycle characteristics.

There are other examples of the solvents, and such examples include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, dimethyl sulfoxide and trimethyl phosphate.

In addition, depending upon the electrode to be combined, there may be some cases that using a compound obtained by substituting a part or all of the hydrogen atoms of a substance included in the foregoing non-aqueous solvent group with a fluorine atom may be desirable, by which the reversibility of an electrode reaction would be improved.

Examples of the electrolyte salt include lithium salt, which may be used either alone or in mixture of two or more. Examples of the lithium salt include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro[oxolato-O,O′] borate, lithium bisoxalate borate and LiBr. Among them, LiPF₆ may be desirable because it makes possible to obtain high ionic conductivity and is able to improve cycle characteristics.

[Manufacturing Method of Battery]

Next, an example of manufacturing method of the non-aqueous electrolyte secondary battery according to the first embodiment of the present application will be described.

First of all, for example, an adhesion layer mixture is prepared by mixing the second particles harder than the positive electrode current collector 21A with the binding agent. This adhesion layer mixture is then dispersed in a solvent such as N-methyl-2-pyrrolidone to provide adhesion layer mixture slurry in a paste form. Subsequently, the adhesion layer mixture slurry is coated on a surface of the positive electrode current collector 21A, then the solvent is dried, and thus the adhesion layer 21D is to be formed.

Next, for example, the first particles containing the positive electrode active material, the conducting agent and the binding agent are mixed to prepare a positive electrode mixture, which is then dispersed in a solvent such as N-methyl-2-pyrrolidone to provide positive electrode mixture slurry in a paste form. Subsequently, the positive electrode mixture slurry is coated on a surface of the adhesion layer 21D, then the solvent is dried, and thus the positive electrode active material layer 21C is to be formed. Then, the adhesion layer 21D and the positive electrode active material layer 21C are subjected to compression molding by a roll press, for example, and thus the positive electrode 21 is to be formed.

In addition, for example, the negative electrode active material and the binding agent are mixed to prepare a negative electrode mixture, which is then dispersed in a solvent such as N-methyl-2-pyrrolidone to provide negative electrode mixture slurry in a paste form. Subsequently, the negative electrode mixture slurry is coated on a surface of the negative electrode current collector 22A, and then the solvent is dried. Then by being subjected to compression molding by a roll press or the like, the negative electrode active material layer 22B is formed, and thus the negative electrode 22 is to be fabricated.

After this, the positive electrode lead 25 is attached to the positive electrode current collector 21A by welding or the like, and the negative electrode lead 26 is attached to the negative electrode current collector 22A by welding or the like. Next, the positive electrode 21 and the negative electrode 22 are spirally wound via the separator 23. Then, while a tip end of the positive electrode lead 25 is welded to the safety valve mechanism 15, a tip end of the negative electrode lead 26 is welded to the battery can 11, and the spirally wound positive electrode 21 and the negative electrode 22 are sandwiched between a pair of the insulating plates 12 and 13, and are housed inside the battery can 11. Subsequently, after housing the positive electrode 21 and the negative electrode 22 inside the battery can 11, the electrolytic solution is injected into the inside of the battery can 11 and the separator 23 is impregnated with the electrolytic solution. After this, the battery cover 14, the safety valve mechanism 15 and the PTC device 16 are caulked via the sealing gasket 17 at the open end of the battery can 11, to be fixed. Thus, the secondary battery shown in FIG. 1 is able to be obtained.

According to the first embodiment as described above, the positive electrode layer 21B includes the first particles containing the positive electrode active material as the main component and the second particles harder than the positive electrode current collector 21A. Further, these second particles are present at least at the interface between the positive electrode current collector 21A and the positive electrode layer 21B. As a result, at the time of pressing, it becomes possible to embed the second particles, which are present at the interface, to be provided into the surface of the positive electrode current collector 21A. By these second particles provided embedded, an anchor effect is allowed to be expressed, and thus it becomes possible to suppress delamination of the interface between the positive electrode current collector 21A and the positive electrode layer 21B.

The positive electrode layer 21B includes the first particles and the second particles, in which the second particles allow the expression of the anchor effect, so some kind of positive electrode active materials (that is, the positive electrode active material softer than the positive electrode current collector 21A) which have been difficult to be used in the past as the first particles because they might have brought about the delamination of the electrode, are able to be used as the first particles.

The second particles present at the interface as described above are provided embedded in the surface of the positive electrode current collector 21A, so when the positive electrode active material particles and other conductive particles are used as the second particles, the interface resistance of the positive electrode current collector 21A and the positive electrode layer 21B decreases, and thus it is possible to improve high-rate load characteristics.

It is possible to reduce the resistance between the positive electrode current collector 21A and the positive electrode layer 21B. In addition, by providing the second particles embedded in the surface of the positive electrode current collector 21A, it becomes possible to form a conductive path, not interposed by the insulating material of the surface of the positive electrode current collector which might be formed due to repeat of charge and discharge. Therefore, the cycle characteristics and high temperature storage characteristics would be improved.

By the anchor effect due to the second particles, it becomes possible to suppress delamination of the interface between the positive electrode current collector 21A and the positive electrode layer 21B, and as a result, it becomes possible to improve adhesiveness of in the positive electrode 21, without as much as possible increasing the overall concentration of the binding agent.

When the positive electrode active material particles are used as the second particles, then, even when the thickness of the adhesion layer 21D is not made thin, it would be made possible to suppress the decrease in the amount of active material per unit volume of the positive electrode layer 21B. Therefore, in order to suppress the decrease in the amount of active material per unit volume, there would not be accompanying a limiting of coating methods for forming the adhesion layer nor an increasing of the load of the process.

### 2. Second Embodiment

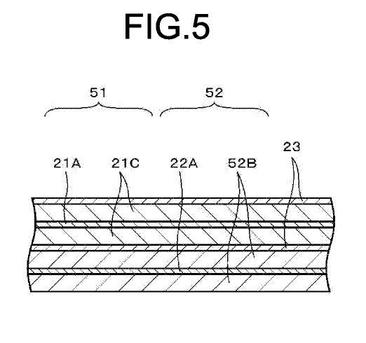

FIG. 5 is a cross-sectional view showing a configuration example of a non-aqueous electrolyte secondary battery according to a second embodiment of the present application. Regarding the second embodiment, substantially the same part as the first embodiment will be denoted by the same reference numerals and will not be described. The non-aqueous electrolyte secondary battery according to the second embodiment has substantially the same configurations as the first embodiment except for those of a positive electrode 51 and a negative electrode 52, so descriptions in the following will be given for the positive electrode 51 and the negative electrode 52.

(Positive Electrode)

The positive electrode 51 includes the positive electrode current collector 21A and the positive electrode active material layers 21C provided on both sides of the positive electrode current collector 21A. In addition, although not shown in the drawing, the positive electrode 21 may be provided with the positive electrode active material layer 21C on only one side of the positive electrode current collector 21A.

(Negative Electrode)

The negative electrode 52 includes the negative electrode current collector 22A and negative electrode layers (electrode layer) 52B provided on both sides of the negative electrode current collector 22A. In addition, although not shown in the drawing, the negative electrode 22 may be provided with the negative electrode layer 52B on only one side of the negative electrode current collector 22A.

(Negative Electrode Layer)

The negative electrode layer 52B includes first particles and second particles. The negative electrode layer 52B may further include the conducting agent such as graphite and the binding agent such as polyvinylidene fluoride if necessary.

The second particles are present at least at an interface between the negative electrode current collector 22A and the negative electrode layer 52B. From the viewpoint of suppressing an increase of the second particles, the second particles may desirably be most abundantly present at the interface with the negative electrode current collector 22A or at the vicinity of the interface of in the negative electrode layer 52B. The second particles may further desirably be present only at the interface and the vicinity thereof. The second particles present at the interface may desirably be embedded in the negative electrode current collector 22A. By providing the second particles embedded as described above, it becomes possible to improve adhesiveness between the negative electrode current collector 22A and the negative electrode layer 52B. In addition, the second particles provided embedded as described above may also be only present in a partial area of the interface between the negative electrode current collector 22A and the negative electrode layer 52B. However, from the viewpoint of improving adhesiveness, the second particles may desirably be present over almost the entire interface.

(First Particles)

The first particles contain a negative electrode active material as the main component. The material to be used as the first particles may be one which is softer than the negative electrode current collector 22A for example. Even when the first particles are softer than the negative electrode current collector 22A as described above, it would be possible to improve adhesiveness between the negative electrode current collector 22A and the negative electrode layer 52B as long as the second particles are provided embedded in the surface of the negative electrode current collector 22A.

It may be determined, by the similar method as those described regarding the above-mentioned first embodiment, whether or not the first particles are softer than the negative electrode current collector 22A.

Examples of particles to be used as the first particles include primary particles and secondary particles, which may be used either alone or in combination of two or more.

The secondary particles may include those which have a core-shell structure having a core portion and a shell portion surrounding the core portion. The core-shell structure may be a structure in which the shell portion covers the core portion completely and may also be a structure in which the shell portion is covering a part of the core portion. In addition, some part of the primary particles of the shell portion may be present as forming a domain or the like in the core particles. Furthermore, a multilayer structure of three or more layers, having one or more layers in different composition from the core portion and the shell portion, between the core portion and the shell portion, may also be included therein.

Examples of possible shapes of the primary particles include spherical, ellipsoidal, acicular, plate-like, scale-like, tubular, wire-shaped, bar-like (rod-like), indeterminate form and the like, but not particularly limited thereto. The types of particles in the above-mentioned shapes may also be used in combination of two or more.

Examples of possible shapes of the secondary particles include spherical, ellipsoidal, acicular, plate-like, scale-like, tubular, wire-shaped, bar-like (rod-like), indeterminate form and the like, but not particularly limited thereto. The types of particles in the above-mentioned shapes may also be used in combination of two or more.

Examples of materials to be used as the negative electrode active material contained in the first particles may include ones which are similar to those of the above-mentioned first embodiment.

(Second Particles)

Particles to be used as the second particles include those which are harder than the negative electrode current collector 22A. By using hard particles as the second particles as described above, it becomes possible to embed the second particles to be provided into the surface of the negative electrode current collector 22A in the press process which will be described later. Therefore, it becomes possible to improve adhesiveness between the negative electrode current collector 22A and the negative electrode layer 52B.

It may be determined, by the similar method as those described regarding the above-mentioned first embodiment, whether or not the second particles are harder than the negative electrode current collector 22A.

When provided that hardness or degree of hardness of the negative electrode current collector 22A is H_{A}, and hardness or degree of hardness of the second particles is H_{C}, the values of hardness or degree of hardness H_{A} and H_{C} satisfy a relationship of H_{A}<H_{C}. By satisfying such a relationship, it becomes possible to embed the second particles into the surface of the negative electrode current collector 22A in the press process which will be described later. Therefore, it becomes possible to improve adhesiveness between the negative electrode current collector 22A and the negative electrode layer 52B.

When provided that hardness or degree of hardness of the negative electrode current collector 22A is H_{A}, hardness or degree of hardness of the second particles is H_{B}, and hardness or degree of hardness of the second particles is H_{C}, the values desirably may satisfy a relationship of H_{B}<H_{A}<H_{C}. By satisfying such a relationship, even when the first particles containing the negative electrode active material are softer than the negative electrode current collector 22A, by the expression of the anchor effect due to the second particles, it would be possible to improve adhesiveness between the negative electrode current collector 22A and the negative electrode layer 52B.

Examples of particles to be used as the second particles include primary particles and secondary particles, which may be used either alone or in combination of two or more. Examples of particle morphology of the second particles may include the same ones and different ones with the first particles.

The secondary particles may include those which have a core-shell structure having a core portion and a shell portion surrounding the core portion. The core-shell structure may be a structure in which the shell portion covers the core portion completely and may also be a structure in which the shell portion is covering a part of the core portion. In addition, some part of the primary particles of the shell portion may be present as forming a domain or the like in the core particles. Furthermore, a multilayer structure of three or more layers, having one or more layers in different composition from the core portion and the shell portion, between the core portion and the shell portion, may also be included therein.

Examples of possible shapes of the primary particles include spherical, ellipsoidal, acicular, plate-like, scale-like, tubular, wire-shaped, bar-like (rod-like), indeterminate form and the like, but not particularly limited thereto. The types of particles in the above-mentioned shapes may also be used in combination of two or more.

Examples of possible shapes of the secondary particles include spherical, ellipsoidal, acicular, plate-like, scale-like, tubular, wire-shaped, bar-like (rod-like), indeterminate form and the like, but not particularly limited thereto. The types of particles in the above-mentioned shapes may also be used in combination of two or more.

There may be used, at least one kind selected from the group consisting of negative electrode active material particles, conductive particles and nonconductive particles, for example, as the second particles. From the viewpoint of suppressing an increase in the interface resistance between the negative electrode current collector 22A and the negative electrode layer 52B, the particles to be used as the second particles may desirably be, at least one kind selected from the group consisting of the negative electrode active material particles and the conductive particles. From the viewpoint of suppressing an increase in the interface resistance between the negative electrode current collector 22A and the negative electrode layer 52B, and, suppressing a decrease in the battery capacity due to that the second particles are included in the negative electrode layer 22B, the particles to be used as the second particles may desirably be the negative electrode active material particles.

Although the negative electrode active material particles are particles which have conductivity in themselves, herein, “the negative electrode active material particles” should not necessarily be included in “the conductive particles”, and the two terms are defined as separate terms.

The negative electrode active material particles are, for example, particles which have conductivity and capability of intercalating and deintercalating lithium, and whose main component is the negative electrode active material. The negative electrode active material is, for example, one or more kinds of negative electrode materials capable of intercalating and deintercalating lithium. Examples of possible materials to be used as the negative electrode material capable of intercalating and deintercalating lithium may include those which have been listed as the negative electrode material regarding the first embodiment as described above.

Particles to be used as the conductive particles and the nonconductive particles may be ones which are similar to those of the above-mentioned first embodiment.

(Configuration of Negative Electrode Layer)

The negative electrode layer 52B has for example, a single layer structure or a multilayer structure of laminated two or more layers. In addition, the negative electrode layer 52B provided on one side of the negative electrode current collector 22A and the negative electrode layer 52B provided on the other side thereof may have different structures from each other.

When the negative electrode layer 52B has the multilayer structure, among the laminated layers, a layer adjacent to the negative electrode current collector 22A may desirably contain the second particles that are harder than the negative electrode current collector 22A.

When the negative electrode layer 52B has the single layer structure, the second particles have a distribution which varies along the thickness direction of the negative electrode layer 52B, for example. The distribution that increases toward a side at the interface between the negative electrode current collector 22A and the negative electrode layer 52B, from the surface opposite to the interface of the negative electrode layer 52B, and becomes the highest at the vicinity of the interface may be desirable. The variation in the distribution of the second particles may be continuous or discontinuous variation, for example. Examples of the distribution which varies discontinuously include a stepwise distribution.

In the following, descriptions for a configuration example of the negative electrode layer 52B having the multilayer structure (hereinafter, referred to as “first configuration example of negative electrode layer”) and a configuration example of the negative electrode layer 52B having the single layer structure (hereinafter, referred to as “second configuration example of negative electrode layer”) will be given in this order.

(First Configuration Example of Negative Electrode Layer)

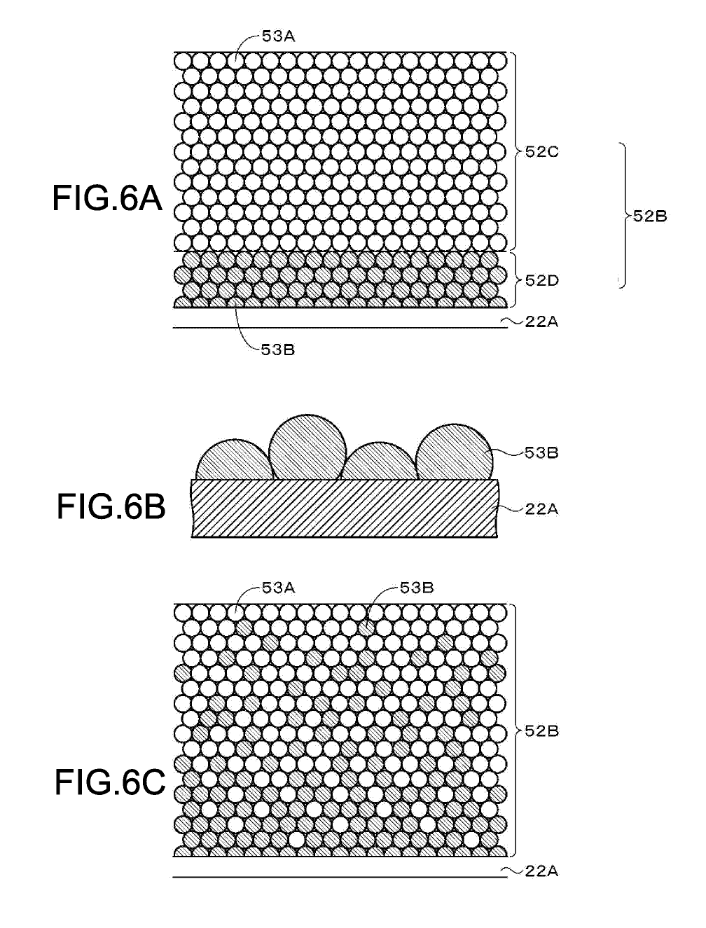

FIG. 6A is a cross-sectional view showing a first configuration example of the negative electrode layer shown in FIG. 5. As shown in FIG. 6A, the negative electrode layer 52B of the first configuration example includes, a negative electrode active material layer 52C, provided on a surface of the negative electrode current collector 22A, and the adhesion layer 52D, provided in between the surface of the negative electrode current collector 22A and a surface of the negative electrode active material layer 52C.

The negative electrode active material layer 52C includes, first particles 53A containing the negative electrode active material as their main component, for example. The negative electrode active material layer 52C may further include the conducting agent such as graphite and the binding agent such as polyvinylidene fluoride if necessary.

The adhesion layer 52D includes, second particles 53B harder than the negative electrode current collector 22A, for example. The adhesion layer 52D may further include the conducting agent such as graphite and the binding agent such as polyvinylidene fluoride if necessary.

FIG. 6B is an enlarged cross-sectional view showing an interface between the negative electrode current collector and the adhesion layer. As shown in FIG. 6B, a part of surfaces of the second particles 53B present at the interface between the negative electrode current collector 22A and the adhesion layer 52D may desirably be provided embedded in the surface of the negative electrode current collector 22A. The entire surface of the second particles 53B present at the vicinity of the interface between the negative electrode current collector 22A and the adhesion layer 52D may also be provided embedded in the surface of the negative electrode current collector 22A.

(Second Configuration Example of Negative Electrode Layer)

FIG. 6C is a cross-sectional view showing a second configuration example of the negative electrode layer shown in FIG. 5. The negative electrode layer 52B of the second configuration example is a negative electrode active material layer including the both of the first particles and the second particles. The negative electrode layer 52B may further include the conducting agent such as graphite and the binding agent such as polyvinylidene fluoride if necessary.

The first particles and the second particles have a distribution which varies along the thickness direction of the negative electrode layer 52B (in a direction from the surface on the side facing the positive electrode 21 across the separator 23, of the negative electrode layer 52B, toward the interface between the negative electrode current collector 22A and the negative electrode layer 52B). Whereas the distribution of the first particles may be the lowest at the side at the interface between the negative electrode current collector 22A and the negative electrode layer 52B, the distribution of the second particles being the highest at the side at the interface may be desirable. More specifically, for example, the distribution of the first particles may gradually vary along the thickness direction of the negative electrode layer 52B in such a way that the distribution becomes the lowest at the side at the interface between the negative electrode current collector 22A and the negative electrode layer 52B. On the other hand, the distribution of the second particles may gradually vary along the thickness direction of the negative electrode layer 52B in such a way that the distribution becomes the highest at the side at the interface between the negative electrode current collector 22A and the negative electrode layer 52B.

### Third Embodiment

[Configuration of Battery]

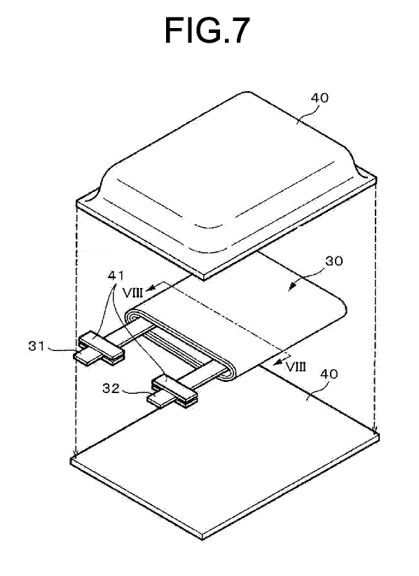

FIG. 7 is an exploded perspective view showing a configuration example of a non-aqueous electrolyte secondary battery according to a third embodiment of the present application. This secondary battery is one in which a spirally wound electrode body 30 with a positive electrode lead 31 and a negative electrode lead 32 attached thereto is housed inside a film-like exterior member 40, and is able to be made smaller, lighter and thinner.

Each of the positive electrode lead 31 and the negative electrode lead 32 is lead out from the inside of the exterior member 40 toward the outside, in the same direction with each other, for example. Each of the positive electrode lead 31 and the negative electrode lead 32 is, for example, made of metal material such as aluminum, copper, nickel and stainless material, each of which may be in thin plate form or mesh form.

The exterior member 40 is made up of rectangular-shaped aluminum laminated film, for example, in which nylon film, aluminum foil and polyethylene film are bonded to each other in that order. The exterior member 40 is arranged such that the side with polyethylene film faces the spirally wound electrode body 30, for example, and each of outer edges thereof is adhered to each other by fusion or use of adhesive. Between the exterior member 40 and each of the positive electrode lead 31 and the negative electrode lead 32, there is inserted an adhesive film 41 for preventing invasion of the outside air. The adhesive film 41 is made of material having adhesion to the positive electrode lead 31 and the negative electrode lead 32, and the material includes, for example, polyolefin resin such as polyethylene, polypropylene, modified polyethylene and modified polypropylene.

It should be noted that the exterior member 40 may also be configured to include instead of the above-mentioned aluminum laminated film, a laminated film having other structure or a polymer film such as polypropylene and metal film.

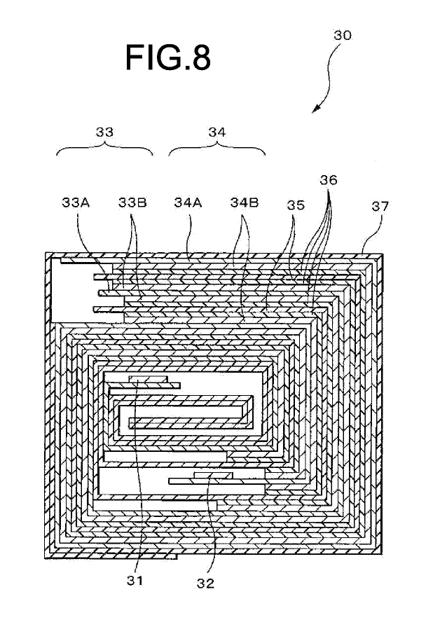

FIG. 8 is a cross-sectional view of the spirally wound electrode body shown in FIG. 7, taken along line VIII-VIII. The spirally wound electrode body 30 has a positive electrode 33 and a negative electrode 34 laminated with a separator 35 and an electrolyte layer 36 in between and spirally wound. The outermost peripheral part of the spirally wound electrode body 30 is protected by a protective tape 37.

The positive electrode 33 has a configuration in which a positive electrode layer 33B is provided on one or both sides of a positive electrode current collector 33A. The negative electrode 34 has a configuration in which a negative electrode active material layer 34B is provided on one or both sides of a negative electrode current collector 34A. The negative electrode active material layer 34B and the positive electrode layer 33B are arranged facing each other. Configurations of the positive electrode current collector 33A, the positive electrode layer 33B, the negative electrode current collector 34A, the negative electrode active material layer 34B and the separator 35 are substantially the same as the positive electrode current collector 21A, the positive electrode layer 21B, the negative electrode current collector 22A, the negative electrode active material layer 22B and the separator 23 in the first embodiment, respectively.

The electrolyte layer 36 includes an electrolytic solution containing a phosphorus compound, and a polymer compound configured to serve as a support material to retain the electrolytic solution, and is in a so-called gelatinous form. The gelatinous electrolyte layer 36 may be desirable, because it makes possible to obtain high ionic conductivity while preventing liquid leakage of the battery. The composition of the electrolytic solution (that is, the solvent, the electrolyte salt and the phosphorus compound and the like) may be similar to that of the secondary battery according to the first embodiment. Examples of the polymer compounds include polyacrylonitrile, polyvinylidene fluoride, a copolymer of polyvinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, a styrene-butadiene rubber, a nitrile-butadiene rubber, polystyrene, polycarbonate and the like. In particular, in terms of electrochemical stability, polyacrylonitrile, polyvinylidene fluoride, polyhexafluoropropylene and polyethylene oxide may be desirable.

[Manufacturing Method of Battery]

Next, an example of manufacturing method of the non-aqueous electrolyte secondary battery according to the third embodiment of the present application will be described.

First of all, a precursor solution containing the solvent, the electrolyte solution, the phosphorus compound as an additive, and the polymer compound, and a mixing solvent is coated on each of the positive electrode 33 and the negative electrode 34, and the electrolyte layer 36 is to be formed by allowing the mixing solvent to volatilize.

Next, the positive electrode lead 31 is attached to an end of the positive electrode current collector 33A by welding, and the negative electrode lead 32 is attached to an end of the negative electrode current collector 34A by welding.

Subsequently, the positive electrode 33 and the negative electrode 34, each having the electrolyte 36 formed thereon, are laminated with the separator 35 therebetween, and thus to be provided as a laminated body. After this, the laminated body is spirally wound in a longitudinal direction thereof, and on its outermost peripheral part, the protective tape 37 is adhered thereto, thereby forming the spirally wound electrode body 30.

Finally, for example, the spirally wound electrode body 30 is interposed in between the exterior member 40, and the outer edges of the exterior member 40 are adhered to each other by thermal fusion or the like, enclosing the spirally wound electrode body 30. At this time, the adhesive film 41 is inserted between each of the positive electrode lead 31 and the negative electrode lead 32 and the exterior member 40. Thus, the secondary battery shown in FIGS. 7 and 8 is able to be obtained.

Alternatively, this secondary battery may be fabricated in the following way. First of all, in such a way as described above, the positive electrode 33 and the negative electrode 34 are fabricated, and the positive electrode lead 31 and the negative electrode lead 32 are then attached thereto.

Next, the positive electrode 33 and the negative electrode 34 are laminated with the separator 35 in between, then spirally wound, and on its outermost peripheral part, the protective tape 37 is adhered thereto, thereby fabricating a spirally wound body which is a precursor of the spirally wound electrode body 30.

Subsequently, the spirally wound body is interposed in between the exterior member 40, and the outer edges of the exterior member 40 excluding one side thereof, are adhered to each other by thermal fusion in a way to be formed as a pouch-shape, thereby housing the spirally wound body in the inside of the exterior member 40. After this, an electrolyte composition containing the solvent, the electrolyte solution, the phosphorus compound as an additive, a monomer as a raw material of the polymer compound, a polymerization initiator, and optionally, other material such as a polymerization inhibitor is prepared, and then be injected inside the exterior member 40.

Subsequently, after injecting the electrolyte composition inside the exterior member 40, an opening of the exterior member 40 is sealed by thermal fusion under vacuum. Then, by allowing the monomer to be polymerized as a polymer compound by heating, the electrolyte layer 36 in gelatinous form is to be formed. Thus, the secondary battery shown in FIG. 7 is able to be obtained.

Operations and effects of the non-aqueous electrolyte secondary battery according to the third embodiment are similar to those of the first embodiment.

### 4. Fourth Embodiment

(Example of Battery Pack)

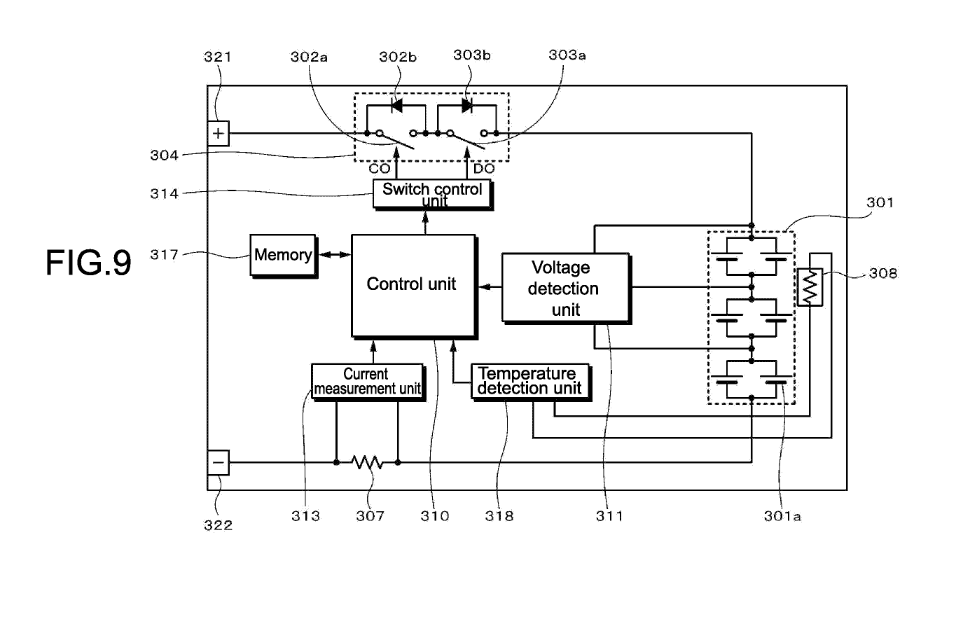

FIG. 9 is a block diagram showing a circuit configuration example of a case where a non-aqueous electrolyte secondary battery (hereinafter, arbitrarily referred to as “secondary battery”) of an embodiment of the present application is applied to a battery pack. The battery pack includes an assembled battery 301, an exterior, a switch unit 304 having a charge control switch 302a and a discharge control switch 303a, a current sensing resistor 307, a temperature sensing device 308, and a control unit 310.

Further, the battery pack includes a positive terminal 321 and a negative terminal 322. In charging, the positive terminal 321 and the negative terminal 322 are connected to a positive terminal and a negative terminal of a charger, respectively, and the charging is carried out. On the other hand, when using an electronic apparatus, the positive terminal 321 and the negative terminal 322 are connected to a positive terminal and a negative terminal of the apparatus, respectively, and the discharge is carried out.

The assembled battery 301 is configured with a plurality of the secondary batteries 301a connected to one another in series and/or in parallel. The secondary battery 301a is a secondary battery of an embodiment of the present application. It should be noted that although there is shown in FIG. 9 a case where the six secondary batteries 301a are connected in two batteries in parallel and three in series (2P3S configuration) as an example, also others, such as n in parallel and m in series (where n and m are integers), and any way of connections may be adopted.

The switch unit 304 includes a charge control switch 302a and a diode 302b, and a discharge control switch 303a and a diode 303b and is controlled by a control unit 310. The diode 302b has the polarity in opposite direction with respect to charge current flowing from the positive terminal 321 to the assembled battery 301 and in forward direction with respect to discharge current flowing from the negative terminal 322 to the assembled battery 301. The diode 303b has the polarity in forward direction with respect to the charge current and in opposite direction with respect to the discharge current. It should be noted that although in this example the switch unit is provided on the positive terminal side, it may otherwise be provided on the negative terminal side.

The charge control switch 302a is configured to be turned off in the case where a battery voltage reaches an overcharge detection voltage, and it is controlled by the control unit 310 such that the charge current does not flow in a current path of the assembled battery 301. After the charge control switch 302a is turned off, only discharge can be performed via the diode 302b. Further, in the case where a large amount of current flows at a time of charge, the charge control switch 302a is turned off and is controlled by the control unit 310 such that the charge current flowing in the current path of the assembled battery 301 is shut off.

The discharge control switch 303a is configured to be turned off in the case where a battery voltage reaches an overdischarge detection voltage, and it is controlled by the control unit 310 such that the discharge current does not flow in a current path of the assembled battery 301. After the discharge control switch 303a is turned off, only charge can be performed via the diode 303b. Further, in the case where a large amount of current flows at a time of discharge, the discharge control switch 303a is turned off and is controlled by the control unit 310 such that the discharge current flowing in the current path of the assembled battery 301 is shut off.

A temperature sensing device 308 is a thermistor, for example, provided in the vicinity of the assembled battery 301. The temperature sensing device 308 is configured to measure a temperature of the assembled battery 301 and supply the measured temperature to the control unit 310. A voltage detection unit 311 is configured to measure voltages of the assembled battery 301 and each of the secondary batteries 301a included in the assembled battery 301, then A/D-convert the measured voltages, and supply them to the control unit 310. A current measurement unit 313 is configured to measure a current using a current detection resistor 307 and supply the measured current to the control unit 310.

The switch control unit 314 is configured to control the charge control switch 302a and the discharge control switch 303a of the switch unit 304 on the basis of the voltage and the current that are input from the voltage detection unit 311 and the current measurement unit 313. The switch control unit 314 is configured to transmit a control signal of the switch unit 304 when a voltage of any one of secondary batteries 301a reaches the overcharge detection voltage or less or the overdischarge detection voltage or less, or, a large amount of current flows rapidly, in order to prevent overcharge, overdischarge, and over-current charge and discharge.

Here, in the case where the secondary batteries 301a are lithium-ion secondary batteries, an overcharge detection voltage is defined to be 4.20 V±0.05 V for example, and an overdischarge detection voltage is defined to be 2.4 V±0.1 V for example.

For a charge and discharge control switch, a semiconductor switch such as a MOSFET (metal-oxide semiconductor field-effect transistor) can be used. In this case, parasitic diodes of the MOSFET function as the diodes 302b and 303b. In the case where p-channel FETs (field-effect transistors) are used as the charge and discharge control switch, the switch control unit 314 supplies a control signal DO and a control signal CO to a gate of the charge control switch 302a and that of the discharge control switch 303a, respectively. In the case where the charge control switch 302a and the discharge control switch 303a are of p-channel type, the charge control switch 302a and the discharge control switch 303a are turned on by a gate potential lower than a source potential by a predetermined value or more. In other words, in normal charge and discharge operations, the control signals CO and DO are determined to be a low level and the charge control switch 302a and the discharge control switch 303a are turned on.

Further, for example, when overcharged or overdischarged, the control signals CO and DO are determined to be a high level and the charge control switch 302a and the discharge control switch 303a are turned off.

A memory 317 includes a RAM (random access memory), a ROM (read only memory), an EPROM (erasable programmable read only memory) serving as a nonvolatile memory, or the like. In the memory 317, numerical values computed by the control unit 310, an internal resistance value of a battery in an initial state of each secondary battery 301a, which has been measured in a stage of a manufacturing process, and the like are stored in advance, and can be rewritten as appropriate. Further, when a full charge capacity of the secondary battery 301a is stored, for example, a remaining capacity can be calculated together with the control unit 310.

A temperature detection unit 318 is provided, to measure the temperature using the temperature sensing device 308 and control charging or discharging when abnormal heat generation has occurred, or perform correction in calculation of the remaining capacity.

### 5. Fifth Embodiment

The above-mentioned non-aqueous electrolyte secondary battery and the battery pack using the same can be installed or be used in providing electricity to apparatus such as electronic apparatus, electric vehicle and electrical storage apparatus, for example.

Examples of electronic apparatus are laptops, PDA (Personal Digital Assistant), cellular phones, cordless telephone handset, video movies, digital still cameras, electronic books, electronic dictionaries, music players, radio, headphones, game machine, navigation system, memory cards, pacemakers, hearing aids, electric tools, electric shavers, refrigerator, air-conditioner, televisions, stereos, water heater, microwave oven, dishwasher, washing machine, dryer, lighting equipments, toys, medical equipments, robots, load conditioners, traffic lights, and the like.

Examples of electric vehicles are railway vehicles, golf carts, electric carts, electric motorcars (including hybrid motorcars), and the like. The above-mentioned embodiments would be used as their driving power source or auxiliary power source.

Examples of electrical storage apparatus include power sources for electrical storage to be used by power generation facilities or buildings such as houses.

Among examples of application mentioned in the above, a specific example of power storage system which has adopted a non-aqueous electrolyte secondary battery in embodiments of the present application will be described below.

The power storage system may employ the following configurations, for example. A first power storage system is a power storage system having an electrical storage apparatus configured to be charged by a power generating device that generates electricity from renewable energy. A second power storage system has an electrical storage apparatus, and is configured to provide electricity to an electronic apparatus connected to the electrical storage apparatus. A third power storage system is a configuration of an electronic apparatus in such a way as to receive electricity supply from an electrical storage apparatus. These power storage systems are realized as a system in order to supply electricity efficiently in cooperation with an external power supply network.

Furthermore, a fourth power storage system is a configuration of an electric vehicle, including a converter configured to receive electricity supply from an electrical storage apparatus and convert the electricity into driving force for vehicle, and further including a controller configured to process information on vehicle control on the basis of information on the electrical storage apparatus. A fifth power storage system is an electricity system including an electricity information transmitting-receiving unit configured to transmit and receive signals via a network to and from other apparatuses, in order to control the charge and discharge of the above-mentioned electrical storage apparatus on the basis of information received by the transmitting-receiving unit. The sixth power storage system is an electricity system configured to receive electricity supply from the above-mentioned electrical storage apparatus or provide the electrical storage apparatus with electricity from at least one of a power generating device and a power network. The power storage system is described below.

(Power Storage System for Houses as Application Example)

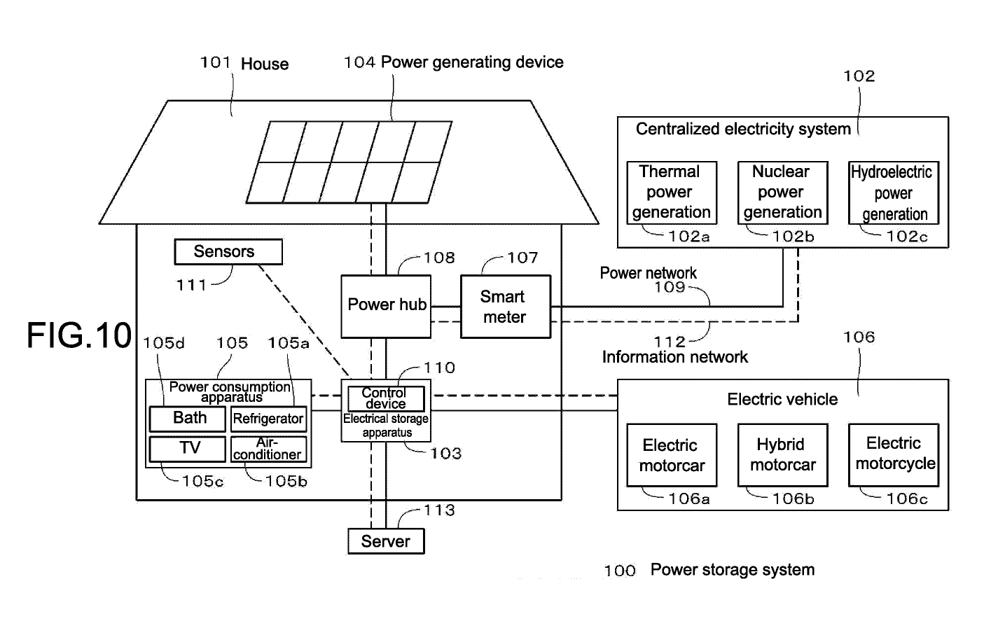

An example of a case where electrical storage apparatus using the non-aqueous electrolyte secondary battery of an embodiment of the present application is applied to power storage system for houses will be described with reference to FIG. 10. For example, in power storage system 100 for a house 101, electricity is provided to an electrical storage apparatus 103 from a centralized electricity system 102 including thermal power generation 102a, nuclear power generation 102b, hydroelectric power generation 102c and the like via power network 109, information network 112, smart meter 107, power hub 108 and the like. Along with this, from independent power source such as in-house power generating device 104, electricity is also provided to the electrical storage apparatus 103. Therefore, electricity given to the electrical storage apparatus 103 is stored. By using the electrical storage apparatus 103, electricity to be used in the house 101 can be supplied. Not only for a house 101, but also with respect to other buildings, similar power storage system can be applied.

The house 101 is provided with the power generating device 104, a power consumption apparatus 105, an electrical storage apparatus 103, a control device 110 that controls each device or apparatus, a smart meter 107, and sensors 111 that obtain various kinds of information. The devices or apparatus are connected to one another through the power network 109 and the information network 112. For the power generating device 104, a solar battery, a fuel battery, or the like is used, and the generated electricity is supplied to the power consumption apparatus 105 and/or the electrical storage apparatus 103. Examples of the power consumption apparatus 105 include a refrigerator 105a, an air-conditioner 105b, a television receiver 105c, and a bath 105d. In addition, the power consumption apparatus 105 includes an electric vehicle 106. Examples of the electric vehicle 106 include an electric motorcar 106a, a hybrid motorcar 106b, and an electric motorcycle 106c.

The above-mentioned non-aqueous electrolyte battery of an embodiment of the present application is applied to the electrical storage apparatus 103. The non-aqueous electrolyte battery of an embodiment of the present application may be, for example, configured by a lithium-ion secondary battery. The smart meter 107 has functions of measuring the used amount of commercial electricity and transmitting the measured used amount to an electricity company. The power network 109 may be any one of DC power feeding, AC power feeding, and noncontact supply of electricity, or may be such that two or more of them are combined.

Examples of various sensors 111 include a human detection sensor, an illumination sensor, an object detection sensor, a power consumption sensor, a vibration sensor, a contact sensor, a temperature sensor and an infrared sensor. The information obtained by the various sensors 111 is transmitted to the control device 110. The state of the weather conditions, the state of a person, and the like are understood on the basis of the information from the sensors 111, and the power consumption apparatus 105 can be automatically controlled to minimize energy consumption. In addition, it is possible for the control device 110 to transmit information on the house 101 to an external electricity company and the like through the Internet.

Processing, such as branching of electricity lines and DC/AC conversion, is performed by using a power hub 108. Examples of a communication scheme for an information network 112 that is connected with the control device 110 include a method of using a communication interface, such as UART (Universal Asynchronous Receiver-Transceiver: transmission and reception circuit for asynchronous serial communication), and a method of using a sensor network based on a wireless communication standard, such as Bluetooth, ZigBee, and WiFi. The Bluetooth method can be applied to multimedia communication, so that one-to-many connection communication can be performed. ZigBee uses the physical layer of IEEE (Institute of Electrical and Electronics Engineers) 802.15.4. IEEE 802.15.4 is the title of the short-distance wireless network standard called personal area network (PAN) or wireless (W) PAN.

The control device 110 is connected to an external server 113. The server 113 may be managed by one of the house 101, an electricity company, and a service provider. The information that is transmitted and received by the server 113 is, for example, information on power consumption information, life pattern information, an electricity fee, weather information, natural disaster information, and electricity transaction. These pieces of information may be transmitted and received from a power consumption apparatus (for example, television receiver) inside a household. Alternatively, the pieces of information may be transmitted and received from an out-of-home device (for example, a mobile phone, etc.). These pieces of information may be displayed on a device having a display function, for example, a television receiver, a mobile phone, or a personal digital assistant (PDA).

The control device 110 that controls each unit includes central processing unit (CPU), a random access memory (RAM), a read only memory (ROM), and the like. In this example, the control device 110 is stored in the electrical storage apparatus 103. The control device 110 is connected to the electrical storage apparatus 103, the in-house power generating device 104, the power consumption apparatus 105, the various sensors 111, and the server 113 through the information network 112, and has functions of adjusting the use amount of the commercial electricity, and the amount of power generation. In addition, the control device 110 may have a function of performing electricity transaction in the electricity market.

As described above, not only the centralized electricity system 102 in which electricity comes from thermal power generation 102a, nuclear power generation 102b, hydroelectric power generation 102c, or the like, but also the generated electricity from the in-house power generating device 104 (solar power generation, wind power generation) can be stored in the electrical storage apparatus 103. Therefore, even if the generated electricity of the in-house power generating device 104 varies, it is possible to perform control such that the amount of electricity to be sent to the outside is made constant or electric discharge is performed by only a necessary amount. For example, usage is possible in which electricity obtained by the solar power generation is stored in the electrical storage apparatus 103, late night power whose fee is low during nighttime is stored in the electrical storage apparatus 103, and the electricity stored by the electrical storage apparatus 103 is discharged and used in a time zone in which the fee during daytime is high.

In this example, an example has been described in which the control device 110 is stored in the electrical storage apparatus 103. Alternatively, the control device 110 may be stored in the smart meter 107 or may be configured singly. In addition, the power storage system 100 may be used by targeting a plurality of households in a block of apartments or may be used by targeting a plurality of single-family detached houses.

(Power Storage System for Vehicles as Application Example)

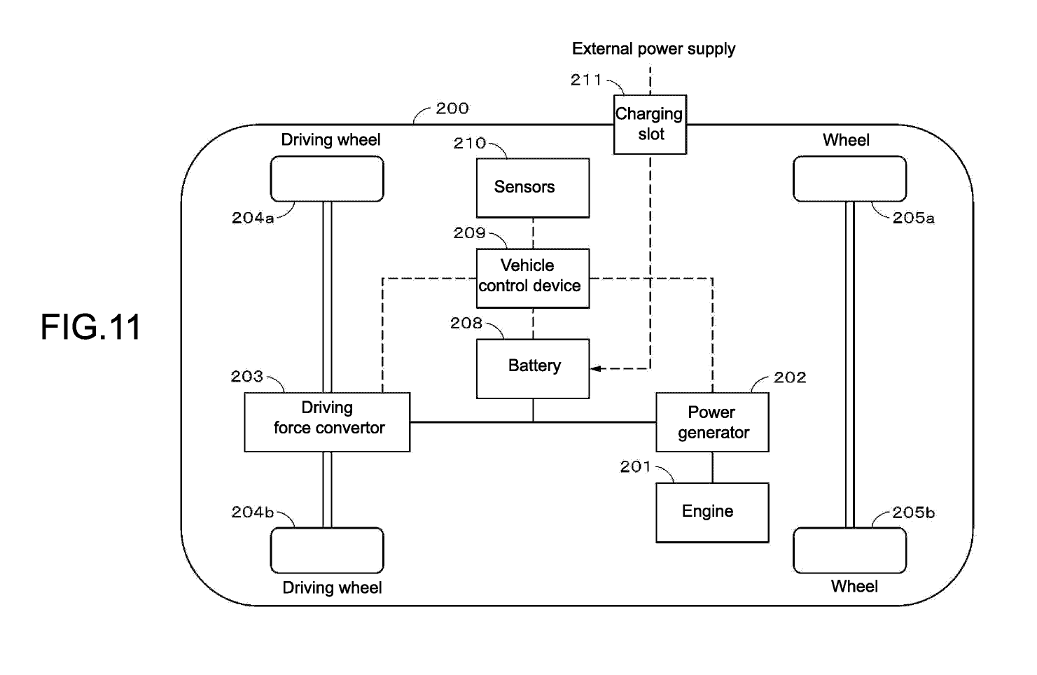

An example of a case where an embodiment of the present application is applied to a power storage system for vehicles will be described with reference to FIG. 11. FIG. 11 schematically shows an example of configuration of a hybrid vehicle employing series-hybrid system, in which an embodiment of the present application is applied. A series-hybrid system is a car that runs using electricity driving force converter by using electricity generated by a power generator that is driven by an engine or by using electricity that is temporarily stored in a battery.

A hybrid vehicle 200 is equipped with an engine 201, a power generator 202, an electricity driving force converter 203, a driving wheel 204a, a driving wheel 204b, a wheel 205a, a wheel 205b, a battery 208, a vehicle control device 209, various sensors 210, and a charging slot 211. The above-mentioned non-aqueous electrolyte secondary battery of an embodiment of the present application is applied to the battery 208.

The hybrid vehicle 200 runs by using the electricity driving force converter 203 as a power source. An example of the electricity driving force converter 203 is a motor. The electricity driving force converter 203 operates using the electricity of the battery 208, and the rotational force of the electricity driving force converter 203 is transferred to the driving wheels 204a and 204b. By using direct current-alternating current (DC-AC) or inverse conversion (AC-DC conversion) at a necessary place, the electricity driving force converter 203 can use any of an AC motor and a DC motor. The various sensors 210 are configured to control the engine revolution speed through the vehicle control device 209 or control the opening (throttle opening) of a throttle valve, although not shown in the drawing. The various sensors 210 include a speed sensor, an acceleration sensor, an engine revolution speed sensor, and the like.

The rotational force of the engine 201 is transferred to the power generator 202, and the electricity generated by the power generator 202 by using the rotational force can be stored in the battery 208.

When a hybrid vehicle 200 decelerates by a braking mechanism, although not shown in the drawing, the resistance force at the time of the deceleration is added as a rotational force to the electricity driving force converter 203. The regenerative electricity generated by the electricity driving force converter 203 by using the rotational force can be stored in the battery 208.

The battery 208, as a result of being connected to an external power supply of the hybrid vehicle 200, receives supply of electricity by using a charging slot 211 as an input slot from the external power supply, and can store the received electricity.

Although not shown in the drawing, the embodiment of the present application may include an information processing device that performs information processing for vehicle control on the basis of information on a secondary battery. Examples of such information processing devices include an information processing device that performs display of the remaining amount of a battery on the basis of the information on the remaining amount of the battery.

In the foregoing, a description has been made referring to an example of a series-hybrid car that runs using a motor by using electricity generated by a power generator that is driven by an engine or by using electricity that had once been stored in a battery. However, the embodiment according to the present application can be effectively applied to a parallel hybrid car in which the outputs of both the engine and the motor are used as a driving source and in which switching between three methods, that is, running using only an engine, running using only a motor, and running using an engine and a motor, is performed as appropriate. In addition, the embodiment according to the present application can be effectively applied to a so-called motor-driven vehicle that runs by driving using only a driving motor without using an engine.

### EXAMPLES

Specific examples of the embodiments of the present application will be described in detail by reference to the following Examples and Comparative Examples. However, the present application should not be construed as limited to the Examples.

(Average Diameter of Primary Particles)

In Examples and Comparative Examples, the average diameter of the primary particles was determined as follows.

First of all, positive electrode active material powder was observed by SEM, and a SEM picture was obtained. Next, from within the SEM picture, 100 grains of the primary particles were randomly selected and were measured the particle size (diameter) thereof. Then, the diameters measured were simply averaged (arithmetic average) and thus the average particle size (average diameter) was determined.

(Average Diameter of Secondary Particles)

In Examples and Comparative Examples, the average diameter of the secondary particles was determined as follows.

First of all, positive electrode active material powder was observed by SEM, and a SEM picture was obtained. Next, from within the SEM picture, 100 grains of the secondary particles were randomly selected and were measured the particle size (diameter) thereof. Then, the average particle size (average diameter) d50 was determined from the diameters measured.

(Average Thickness)

In Examples and Comparative Examples, the average thickness of the adhesion layer and of the positive electrode active material layer (the average thickness before the press process) was determined as follows.

First of all, the adhesion layer was deposited, and then a point located thereon was randomly selected and was measured of its thickness of the adhesion layer together with the current collector by a constant pressure micrometer, in which, the thickness of the adhesion layer was measured by subtracting the thickness of the current collector. This measurement was carried out in ten randomly selected points, then, the measured values obtained were simply averaged (arithmetic average) and thus the average thickness of the adhesion layer was determined.

Subsequently, the positive electrode active material layer was deposited upon the adhesion layer. The average thickness of the positive electrode active material layer was determined by a method similar to that as described above.

(Positive Electrode Mixture)

In Examples and Comparative Examples, positive electrode mixtures A to E were prepared as follows.

(Positive electrode mixture A (positive electrode)) First of all, powder of lithium phosphate (Li₃PO₄), manganese (II) phosphate trihydrate (Mn₃(PO₄)₂.3(H₂O)) and iron (II) phosphate octahydrate (Fe₃(PO₄)₂.8(H₂O)), as raw material, was weighed to 50 grams as a whole with the composition Li:Mn:Fe:P=1:0.75:0.25:1 by mole ratio, and was put into 200 cc of pure water and stirred to be provided as slurry. Next, into the slurry of the raw material, 5 grams of maltose was added, and the mixed slurry was sufficiently stirred in the tank.

Subsequently, the above-mentioned mixed slurry of the raw material was thoroughly mixed and pulverized using a mechanochemical (MC) method. In such a case, the pulverization, as the MC method, was carried out for 24 hours by a planetary ball mill. Then, the pulverized slurry obtained was subjected to spray-drying granulation by a spray dryer at an intake air temperature of 200° C., and thus was provided as precursor powder. After this, the precursor was calcinated under 100% N₂ atmosphere at 600° C. for three hours, and thus the positive electrode active material (LiFe_{0.25}Mn_{0.75}PO₄) was obtained.

Then, the positive electrode active material obtained was observed by SEM.

As a result, it turned out that in this positive electrode active material, a plurality of spherical primary particles was gathered to form a spherical secondary particle. Further, the average diameter of the primary particles determined from the SEM image was about 0.09 μm. The average diameter of the secondary particles was about 4 μm.

Ninety-one % by mass of the positive electrode active material obtained as described above, 2% by mass of amorphous carbon powder (Ketjen black) with 3% by mass of carbon nanotube as the conducting agent, and, 4% by mass of polyvinylidene fluoride (PVDF) as the binding agent, were mixed to prepare positive electrode mixture A.

(Positive Electrode Mixture B)

Positive electrode mixture B was prepared as in the preparation method of the positive electrode mixture A of the foregoing, except that the process of spray-drying granulation by the spray dryer was omitted and the calcination temperature was set at 850° C. to obtain the positive electrode active material (LiFe_{0.25}Mn_{0.75}PO₄).

In addition, as in the positive electrode mixture A of the foregoing, the positive electrode active material was observed by SEM before the preparation of the positive electrode mixture B.

As a result, it turned out that in this positive electrode active material, spherical primary particles were not forming secondary particles but still present as the spherical primary particles. Further, the average diameter of the primary particles of the positive electrode active material determined from the SEM image was about 0.5 μm.

(Positive Electrode Mixture C)

Positive electrode mixture C was prepared as in the preparation method of the positive electrode mixture B, except that the powder of lithium phosphate and manganese (II) phosphate trihydrate as raw material was provided with the composition Li:Mn:P=1:1:1 by mole ratio and the calcination temperature was set at 800° C. to obtain the positive electrode active material (LiMnPO₄).

In addition, as in the positive electrode mixture A of the foregoing, the positive electrode active material was observed by SEM before the preparation of the positive electrode mixture C.

As a result, it turned out that in this positive electrode active material, spherical primary particles were not forming secondary particles but still present as the spherical primary particles. Further, the average diameter of the primary particles of the positive electrode active material determined from the SEM image was about 0.4 μm.

(Positive Electrode Mixture D)

Positive electrode mixture D was prepared as in the preparation method of the positive electrode mixture A, except that the powder of lithium phosphate and iron (II) phosphate octahydrate as raw material was provided with the composition Li:Fe:P=1:1:1 by mole ratio.

In addition, as in the positive electrode mixture A of the foregoing, the positive electrode active material was observed by SEM before the preparation of the positive electrode mixture D.

As a result, it turned out that in this positive electrode active material, a plurality of spherical primary particles was gathered and to form a spherical secondary particle. Further, the average diameter of the primary particles of the positive electrode active material (LiFePO₄) determined from the SEM image was about 0.1 μm. The average diameter of the secondary particles was about 5 μm.

(Positive Electrode Mixture E)

Positive electrode mixture E was prepared as in the preparation method of the positive electrode mixture A, except that the components were mixed in the following proportions.

Positive electrode active material: 78% by mass of LiFe_{0.25}Mn_{0.75}PO₄

Conducting agent: 3% by mass of amorphous carbon powder (Ketjen black); and 4% by mass of carbon nanotube

Binding agent: 15% by mass of polyvinylidene fluoride (PVDF)

(Adhesion Layer Mixture)

In Examples and Comparative Examples, adhesion layer mixtures A to G were prepared as follows.

(Adhesion Layer Mixture A)

Adhesion layer mixture A was prepared as in the preparation method of the positive electrode mixture D, except that the components were mixed in the following proportions.

Positive electrode active material: 86.5% by mass of LiFePO₄

Conducting agent: 3% by mass of amorphous carbon powder (Ketjen black); and 4% by mass of carbon nanotube

Binding agent: 6.5% by mass of polyvinylidene fluoride (PVDF)

(Adhesion Layer Mixture B)

Adhesion layer mixture B was prepared as in the preparation method of the positive electrode mixture A, except that the following components were mixed.

Positive electrode active material: 43.25% by mass of LiFe_{0.25}Mn_{0.75}PO₄; and 43.25% by mass of LiFePO₄

Conducting agent: 3% by mass of amorphous carbon powder (Ketjen black); and 4% by mass of carbon nanotube

Binding agent: 6.5% by mass of polyvinylidene fluoride (PVDF)

In addition, LiFe_{0.25}Mn_{0.75}PO₄ was prepared as in the preparation of the positive electrode active material used in the positive electrode mixture A. Besides, LiFePO₄ was prepared with the composition as in the preparation of the positive electrode active material used in the positive electrode mixture D.

(Adhesion Layer Mixture C)

Adhesion layer mixture C was prepared as in the preparation method of the adhesion layer mixture B, except that the following components were mixed.

Positive electrode active material: 69.2% by mass of LiFe_{0.25}Mn_{0.75}PO₄; and 17.3% by mass of LiFePO₄

Conducting agent: 3% by mass of amorphous carbon powder (Ketjen black); and 4% by mass of carbon nanotube

Binding agent: 6.5% by mass of polyvinylidene fluoride (PVDF)

In addition, LiFe_{0.25}Mn_{0.75}PO₄ was prepared as in the preparation of the positive electrode active material used in the positive electrode mixture A. Besides, LiFePO₄ was prepared with the composition as in the preparation of the positive electrode active material used in the positive electrode mixture D.

(Adhesion Layer Mixture D)

Adhesion layer mixture D was prepared as in the preparation method of the positive electrode mixture D, except that the calcination temperature was set at 850° C. and the following components were mixed.

Positive electrode active material: 86.5% by mass of LiFePO₄

Conducting agent: 3% by mass of amorphous carbon powder (Ketjen black); and 4% by mass of carbon nanotube

Binding agent: 6.5% by mass of polyvinylidene fluoride (PVDF)

In addition, as in the positive electrode mixture A of the foregoing, the positive electrode active material was observed by SEM before the preparation of the adhesion layer mixture D.

As a result, it turned out that in this positive electrode active material, spherical primary particles were not forming secondary particles but still present as the spherical primary particles. Further, the average diameter of the primary particles of the positive electrode active material determined from the SEM image was about 0.5 μm.

(Adhesion Layer Mixture E)

Adhesion layer mixture E was prepared as in the preparation method of the adhesion layer mixture D, except that the process of spray-drying granulation by the spray dryer was omitted and the calcination temperature was set at 750° C.

In addition, as in the positive electrode mixture A of the foregoing, the positive electrode active material was observed by SEM before the preparation of the adhesion layer mixture E.

As a result, it turned out that in this positive electrode active material, spherical primary particles were not forming secondary particles but still present as the spherical primary particles. Further, the average diameter of the primary particles of the positive electrode active material determined from the SEM image was about 0.3 μm.

(Adhesion Layer Mixture F)

Adhesion layer mixture F was prepared as in the preparation method of the positive electrode mixture B, except that the components were mixed in the following proportions.

Positive electrode active material: 86.5% by mass of LiFe_{0.25}Mn_{0.75}PO₄

Conducting agent: 3% by mass of amorphous carbon powder (Ketjen black); and 4% by mass of carbon nanotube

Binding agent: 15% by mass of polyvinylidene fluoride (PVDF)

(Adhesion Layer Mixture G)

Adhesion layer mixture G was prepared as in the preparation method of the adhesion layer mixture A, except that 86.5% by mass of graphite powder having an average particle diameter of 7 μm was added in place of the addition of the positive electrode active material.

Positive electrodes of Examples 1 to 9 and Comparative Examples 1 to 5 were fabricated as follows, using the foregoing positive electrode mixtures A to E and the adhesion layer mixtures A to G.

### Example 1

First of all, the adhesion layer mixture A was uniformly coated on the positive electrode current collector made of strip-like aluminum foil (product name: 1N30, with aluminum purity of 99.30% or more, manufactured by NIPPON FOIL MFG CO., LTD.) having a thickness of 15 μm, and then was dried. Thus, the adhesion layer having an average thickness of 3 μm was formed on the positive electrode current collector.

Subsequently, the positive electrode mixture A was uniformly coated on the dried adhesion layer, and then was dried. Thus, the positive electrode material layer having an average thickness of 57 μm was formed, and a positive electrode was obtained. Then, this positive electrode was stamped out into a circular shape having a diameter of 16 mm to provide a circular positive electrode. Afterward, the circular positive electrode was compressed at a pressure of 20 MPa by a pressing machine. Thus, a positive electrode as intended was obtained.

### Example 2

A positive electrode was obtained as in Example 1, except that the adhesion layer was made to have an average thickness of 8 μm and the positive electrode material layer was made to have an average thickness of 57 μm by adjusting the coating process of the adhesion layer mixture A and the positive electrode mixture A.

### Example 3

A positive electrode was obtained as in Example 1, except that the adhesion layer was made to have an average thickness of 12 μm and the positive electrode material layer was made to have an average thickness of 48 μm by adjusting the coating process of the adhesion layer mixture A and the positive electrode mixture A.

### Example 4

A positive electrode was obtained as in Example 1, except that the adhesion layer mixture B was used in place of the adhesion layer mixture A.

### Example 5

A positive electrode was obtained as in Example 1, except that the adhesion layer mixture C was used in place of the adhesion layer mixture A.

### Example 6

A positive electrode was obtained as in Example 1, except that the adhesion layer mixture D was used in place of the adhesion layer mixture A.

### Example 7

A positive electrode was obtained as in Example 1, except that the adhesion layer mixture E was used in place of the adhesion layer mixture A.

### Example 8

A positive electrode was obtained as in Example 1, except that the adhesion layer mixture F was used in place of the adhesion layer mixture A.

### Example 9

A positive electrode was obtained as in Example 1, except that the adhesion layer mixture G was used in place of the adhesion layer mixture A, and the adhesion layer was made to have an average thickness of 8 μm and the positive electrode material layer was made to have an average thickness of 52 μm by adjusting the coating process of the adhesion layer mixture G and the positive electrode mixture A.

### Comparative Example 1

Without formation of the adhesion layer on the positive electrode current collector, the positive electrode mixture A was directly coated on the positive electrode current collector and was dried. Thus, the positive electrode material layer having an average thickness of 60 μm was formed, and a positive electrode was obtained. Then, this positive electrode was stamped out into a circular shape having a diameter of 16 mm to provide a circular positive electrode. Afterward, the circular positive electrode was compressed at a pressure of 20 MPa by a pressing machine. Thus, a positive electrode as intended was obtained.

### Comparative Example 2

A positive electrode was obtained as in Comparative Example 1, except that the positive electrode mixture B was used in place of the positive electrode mixture A.

### Comparative Example 3

A positive electrode was obtained as in Comparative Example 1, except that the positive electrode mixture C was used in place of the positive electrode mixture A.

### Comparative Example 4

A positive electrode was obtained as in Comparative Example 1, except that the positive electrode mixture D was used in place of the positive electrode mixture A.

### Comparative Example 5

A positive electrode was obtained as in Comparative Example 1, except that the positive electrode mixture E was used in place of the positive electrode mixture A.

(Adhesiveness)

Regarding the positive electrodes of Examples 1 to 9 and Comparative Examples 1 to 5 obtained as described above, the adhesiveness was evaluated as follows.

First of all, regarding the positive electrode obtained, whether or not delamination had occurred at the interface between the positive electrode current collector and the adhesion layer or at the interface between the positive electrode current collector and the positive electrode active material layer was determined.

Next, using the positive electrode in which delamination did not occur, a coin-shaped non-aqueous electrolyte secondary battery was fabricated, and then the discharge capacity of the battery was evaluated.

The coin-shaped non-aqueous electrolyte secondary battery was fabricated as follows.

First, lithium foil stamped out into a circular plate shape of predetermined dimensions was prepared as the negative electrode. Next, the non-aqueous electrolyte was prepared by dissolving LiPF₆ as the electrolyte salt at a concentration of 1 mol/dm³ to the solvent of ethylene carbonate and methyl ethyl carbonate mixed in a proportion of 1:1 by volume ratio.

Subsequently, the pellet-shaped positive electrode and the negative electrode fabricated were laminated with a porous polyolefin film in between, and then housed into an exterior cup and inside the exterior cans, and caulked via a gasket, thus the coin-shaped battery having a diameter of 20 mm and a height of 1.6 mm was fabricated.

After this, the discharge capacity of the coin-shaped non-aqueous electrolyte secondary battery fabricated as described above was evaluated as follows.

First, after charging under CCCV (Constant Current Constant Voltage) conditions at 0.1 C for 20 hours where the voltage was up to 4.25V, discharging was carried out at a discharge current of 0.2 C to a potential of 2V versus Li/Li⁺. The charging and discharging under the foregoing charge-and-discharge conditions was repeated, and the discharge capacity in the second and 300th cycle was measured. Next, using the values of discharge capacity of the second cycle and the 300th cycle, the capacity retention rate after 300 cycles was determined by the following equation.

Capacity retention rate after 300 cycles [%]=(discharge capacity of the 300th cycle/discharge capacity of the second cycle)×100

Subsequently, using the foregoing evaluation results of the determination of whether or not delamination had occurred, and the capacity retention rate, the adhesiveness of the positive electrode was evaluated.

The results of this evaluation were as shown in Table 3, indicated by the marks of “double circle” meaning “very good”, “white circle” meaning “good” and “x mark” meaning “bad”. In addition, the “double circle”, the “white circle” and the “x mark” represent the evaluation results as follows.

⊚: When delamination did not occur at the interface between the positive electrode current collector and the adhesion layer nor at the interface between the positive electrode current collector and the positive electrode active material layer, and, the battery did not show significant decrease in the capacity retention rate after 300 cycles, the adhesiveness of the interface in the positive electrode was determined “very good”.

◯: When delamination did not occur at the interface between the positive electrode current collector and the adhesion layer nor at the interface between the positive electrode current collector and the positive electrode active material layer, but nevertheless the battery showed significant decrease in the capacity retention rate after 300 cycles, the adhesiveness of the interface in the positive electrode was determined “good”.

x: When delamination had occurred at the interface between the positive electrode current collector and the adhesion layer or at the interface between the positive electrode current collector and the positive electrode active material layer, and it was not able to be measured the capacity retention rate thereof, the adhesiveness of the interface in the positive electrode was determined “bad”.

(Indentation)

Among the positive electrodes of Examples 1 to 9 and Comparative Examples 1 to 5 obtained as described above, regarding the positive electrode in which delamination of the interface was observed in the foregoing “evaluation of the adhesiveness after pressing”; the presence or absence of indentation (dent) in the delaminated surface of the positive electrode current collector was evaluated as follows.

First, the positive electrode current collector which had been peeled off was cut out providing its cross-section by FIB processing, and subsequently, the cross-section was observed by SEM, and a cross-sectional SEM image was obtained. Subsequently, on the basis of the cross-sectional SEM image, the presence or absence of indentation (dent) in the delaminated surface of the positive electrode current collector was determined. The results were as shown in Table 3.

Among the positive electrodes of Examples 1 to 9 and Comparative Examples 1 to 5 obtained as described above, regarding the positive electrode in which delamination of the interface was not observed in the foregoing “evaluation of the adhesiveness after pressing”; the presence or absence of indentation (dent) in the delaminated surface of the positive electrode current collector was evaluated as follows.

First, the positive electrode current collector was immersed in a solvent to be subjected to a cleaning process by an ultrasonic cleaner, thereby allowing the positive electrode to be peeled at the interface. Subsequently, in a similar way to the above-mentioned positive electrode which was observed the delamination of the interface thereof, the presence or absence of indentation (dent) in the delaminated surface of the positive electrode current collector was also determined based on the cross-sectional SEM image. The results were as shown in Table 3.

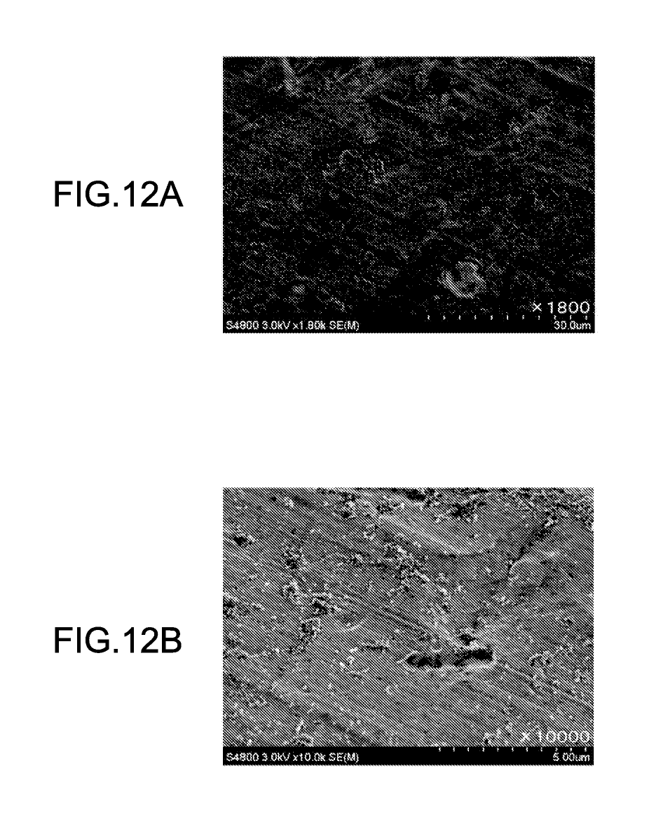

FIG. 12A shows a SEM image of the delaminated surface of the positive electrode current collector in Comparative Example 1. FIG. 12B shows a further enlarged SEM image showing a part of the SEM image of FIG. 12A. The SEM images shown in FIGS. 12A and 12B are top-view SEM images. FIGS. 12A and 12B showed that in the delaminated surface of the positive electrode current collector of Comparative Example 1, the first particles (secondary particles) were not present, the indentations were not formed, and patterns that had been formed when rolling aluminum foil were being formed. In addition, although not shown specifically, among Examples 1 to 9 and Comparative Examples 2, 3 and 5, regarding the examples in which the indentations were not observed, SEM images almost the same as those of Comparative Example 1 shown in FIGS. 12A and 12B were observed.

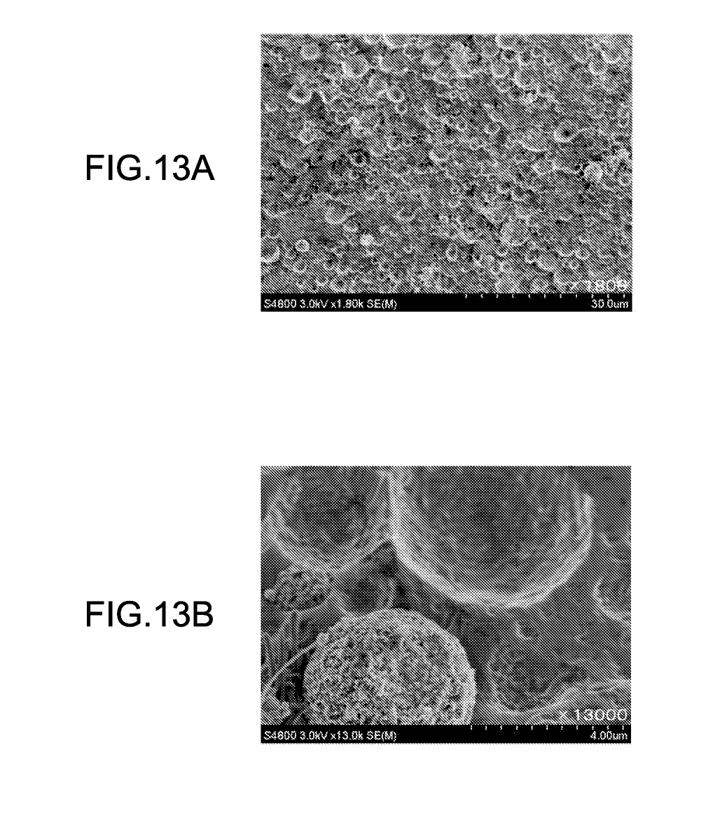

FIG. 13A shows a SEM image of the delaminated surface of the positive electrode current collector in Comparative Example 4. FIG. 13B shows a further enlarged SEM image showing a part of the SEM image of FIG. 13A. The SEM images shown in FIGS. 13A and 13B are top-view SEM images. FIGS. 13A and 13B showed that in the delaminated surface of the positive electrode current collector of Comparative Example 4, the first particles (secondary particles) were present over almost the entire surface and a part of surfaces of those particles were embedded in the delaminated surface. In addition, although not shown specifically, among Examples 1 to 9 and Comparative Examples 2, 3 and 5, regarding the examples in which the indentations were observed, SEM images almost the same as those of Comparative Example 1 shown in FIGS. 13A and 13B were observed.

(Hardness of Particles)

Hardness of the first particles and the second particles used in the fabrication of the positive electrodes of Examples 1 to 9 and Comparative Examples 1 to 5 as described above was evaluated as follows.

a) Hardness of First Particles

First of all, the positive electrode mixtures A to E including the first particles were uniformly coated on the positive electrode current collectors, made of strip-like aluminum foil having a thickness of 15 μm, and then were dried, and thus, positive electrodes were obtained. Then, these positive electrodes were stamped out into a circular shape having a diameter of 16 mm to provide circular positive electrodes. Afterward, the circular positive electrodes were compressed at a pressure of 20 MPa by a pressing machine. Thus, positive electrodes of the samples were obtained.

After this, as in the foregoing “evaluation of indentation”, the presence or absence of indentation (dent) in the surface of the positive electrode current collector was determined. Subsequently, on the basis of the presence or absence of indentation (dent), whether or not the first particles were harder than the positive electrode current collector was determined.

The results of this evaluation were as shown in Table 3. In addition, in Table 3, “Hard” and “Soft” represent the evaluation results as follows.

Hard: When there were indentations present in the surface of the positive electrode current collector, and the first particles were determined harder than the positive electrode current collector

Soft: When there were no indentations in the surface of the positive electrode current collector, and the first particles were determined softer than the positive electrode current collector

b) Hardness of Second Particles

First, positive electrodes were obtained as in the foregoing evaluation of “a) Hardness of first particles”, except that the adhesion layer mixtures A to G including the second particles, and then, on the basis of the presence or absence of indentation (dent), whether or not the second particles were harder than the positive electrode current collector was determined.

The results of this evaluation were as shown in Table 3. In addition, in Table 3, “Hard” and “Soft” represent the evaluation results as follows.

Hard: When there were indentations present in the surface of the positive electrode current collector, and the second particles were determined harder than the positive electrode current collector

Soft: When there were no indentations in the surface of the positive electrode current collector, and the second particles were determined softer than the positive electrode current collector

(Occurrence of Crushing)

Presence or absence of occurrence of crushing in the first particles and the second particles included in the positive electrodes of Examples 1 to 9 and Comparative Examples 1 to 5 as described above was evaluated as follows.

First of all, the positive electrode was cut out providing its cross-section by FIB processing, and subsequently, the cross-section was observed by SEM, and a cross-sectional SEM image was obtained. Subsequently, on the basis of the cross-sectional SEM image, it was determined whether or not the second particles included in the adhesion layer and the first particles included in the positive electrode current collector had been crushed.

The results were as shown in Table 3.

(Discharge Capacity)

Using the positive electrodes obtained as described above, coin-shaped non-aqueous electrolyte secondary batteries were fabricated, and then the discharge capacity of the battery thereof was evaluated.

The coin-shaped non-aqueous electrolyte secondary battery was fabricated as follows.

First, lithium foil stamped out into a circular plate shape of predetermined dimensions was prepared as the negative electrode. Next, the non-aqueous electrolyte was prepared by dissolving LiPF₆ as the electrolyte salt at a concentration of 1 mol/dm³ to the solvent of ethylene carbonate and methyl ethyl carbonate mixed in a proportion of 1:1 by volume ratio.

Subsequently, the pellet-shaped positive electrode and the negative electrode fabricated were laminated with a porous polyolefin film in between, and then housed into an exterior cup and inside the exterior cans, and caulked via a gasket, thus the coin-shaped battery having a diameter of 20 mm and a height of 1.6 mm was fabricated.

After this, the discharge capacity of the coin-shaped non-aqueous electrolyte secondary battery fabricated as described above was evaluated as follows.

First, after charging under CCCV (Constant Current Constant Voltage) conditions at 0.1 C for 20 hours where the voltage was up to 4.25V, discharging was carried out at a discharge current of 0.2 C to a potential of 2V versus Li/Li⁺, and the discharge capacity at 0.2 C was determined. Then, the discharge capacity at 3 C and 5 C was determined as in the discharge capacity at 0.2 C, except that the discharge current after charging was set to 3 C and 5 C respectively. The results were as shown in Table 3.

It should be noted that “1 C” is the current value to discharge by constant current discharge the rated capacity of the battery in one hour. Accordingly, “0.2 C” is the current value to discharge the rated capacity of the battery in five hours. “3 C” is the current value to discharge the rated capacity of the battery in 20 minutes. “5 C” is the current value to discharge the rated capacity of the battery in 12 minutes.

(Energy Density)

The energy density of the non-aqueous electrolyte secondary battery using the positive electrode obtained as described above was determined as follows.

Typically, energy density represents the nominal voltage multiplied by the nominal capacity, and is used in comparing the lasting time at a constant power. In Examples and Comparative Examples, since the active materials having several discharge voltages were included, the value of voltage would have varied depending on depth of discharge. Therefore, the energy density was calculated by integrating the value obtained during discharging until the end of the discharge, while constantly obtaining the value from multiplying the current value by the voltage value at the same time, and was compared with each other.

The results were as shown in Table 4.

Table 1 shows the configurations of the adhesion layers in the positive electrodes of Examples 1 to 9 and Comparative Examples 1 to 5.

TABLE 1

| | Adhesion layer | | | |
|---|---|---|---|---|
| | | Second particles/Third particles | | |
| | Adhesion layer mixture type | Particle type | Particle material | |
| Ex. 1 | Adhesion layer mixture A | Second particles | LiFePO₄ | |
| Ex. 2 | Adhesion layer mixture A | Second particles | LiFePO₄ | |
| Ex. 3 | Adhesion layer mixture A | Second particles | LiFePO₄ | |
| Ex. 4 | Adhesion layer mixture B | Second particles | LiFePO₄ (50% by mass) | |
| | | Third particles | LiMn_{0.75}Fe_{0.25}PO₄ (50% by mass) | |
| Ex. 5 | Adhesion layer mixture C | Second particles | LiFePO₄ (20% by mass) | |
| | | Third particles | LiMn_{0.75}Fe_{0.25}PO₄ (80% by mass) | |
| Ex. 6 | Adhesion layer mixture D | Second particles | LiFePO₄ | |
| Ex. 7 | Adhesion layer mixture E | Second particles | LiFePO₄ | |
| Ex. 8 | Adhesion layer mixture F | Second particles | LiMn_{0.75}Fe_{0.25}PO₄ | |
| Ex. 9 | Adhesion layer mixture G | Second particles | Large diameter carbon | |
| Comp. Ex. 1 | — | — | — | |
| Comp. Ex. 2 | — | — | — | |
| Comp. Ex. 3 | — | — | — | |
| Comp. Ex. 4 | — | — | — | |
| Comp. Ex. 5 | — | — | — | |
| Second particles/Third particles | | | | |
| | Average diameter of | Average diameter | Content of | Average |
| | secondary particles (d50 | of primary | binding agent | thickness |
| Particle morphology | particle diameter) (μm) | particles (μm) | (mass %) | (μm) |
| secondary particle | 5 | 0.1 | 6.5 | 3 |
| secondary particle | 5 | 0.1 | | 8 |
| secondary particle | 5 | 0.1 | | 12 |
| secondary particle | 5 | 0.1 | | 3 |
| secondary particle | 4 | 0.09 | | |
| secondary particle | 5 | 0.1 | | 3 |
| secondary particle | 4 | 0.09 | | |
| primary particle | — | 0.5 | | 3 |
| primary particle | — | 0.3 | | 3 |
| primary particle | — | 0.5 | | 3 |
| primary particle | — | 7 | | 8 |
| — | — | — | — | — |
| — | — | — | — | — |
| — | — | — | — | — |
| — | — | — | — | — |
| — | — | — | — | — |

Table 2 shows the configurations of the positive electrode active material layers in the positive electrodes of Examples 1 to 9 and Comparative Examples 1 to 5.

TABLE 2

| | Positive electrode active material layer | | |
|---|---|---|---|
| | | First particles | |
| | | | Atomic ratio |
| | Positive electrode mixture type | Active material | Fe/Mn |
| Ex. 1 | Positive electrode mixture A | LiMnFePO₄ | 0.25/0.75 |
| Ex. 2 | Positive electrode mixture A | | |
| Ex. 3 | Positive electrode mixture A | | |
| Ex. 4 | Positive electrode mixture A | | |
| Ex. 5 | Positive electrode mixture A | | |
| Ex. 6 | Positive electrode mixture A | | |
| Ex. 7 | Positive electrode mixture A | | |
| Ex. 8 | Positive electrode mixture A | | |
| Ex. 9 | Positive electrode mixture A | | |
| Comp. Ex. 1 | Positive electrode mixture A | LiMnFePO₄ | 0.25/0.75 |
| Comp. Ex. 2 | Positive electrode mixture B | LiMnFePO₄ | 0.25/0.75 |
| Comp. Ex. 3 | Positive electrode mixture C | LiMnPO₄ | — |
| Cornp. Ex. 4 | Positive electrode mixture D | LiFePO₄ | — |
| Comp. Ex. 5 | Positive electrode mixture E | LiMnFePO₄ | 0.25/0.75 |

Positive electrode active material layer

| First particles | | | | |
|---|---|---|---|---|
| | Average diameter of | Average diameter | Content of | Average |
| | secondary particles | of primary particles | binding agent | thickness |
| Particle morphology | (d50 particle diameter) (μm) | (μm) | (mass %) | (μm) |
| secondary particle | 4 | 0.09 | 4 | 57 |
| | | | | 52 |
| | | | | 48 |
| | | | | 57 |
| | | | | 57 |
| | | | | 57 |
| | | | | 57 |
| | | | | 57 |
| | | | | 52 |
| secondary particle | 4 | 0.09 | 4 | 60 |
| primary particle | — | 0.5 | 4 | 60 |
| primary particle | — | 0.4 | 4 | 60 |
| secondary particle | 5 | 0.1 | 4 | 60 |
| secondary particle | 4 | 0.09 | 15 | 60 |

Table 3 shows the evaluation results on the positive electrodes and on the non-aqueous electrolyte secondary batteries using the same, of Examples 1 to 9 and Comparative Examples 1 to 5.

TABLE 3

| | Evaluation results | | | | |
|---|---|---|---|---|---|
| | | | Occurrence | Occurrence | Occurrence |
| | Adhesiveness after | Presence of | of crushing | of crushing | of crushing |
| | pressing | indentation | in first particles | in second particles | in third particles |
| Ex. 1 | ⊚ | Yes | Yes | No | — |
| Ex. 2 | ⊚ | Yes | | No | — |
| Ex. 3 | ⊚ | Yes | | No | — |
| Ex. 4 | ⊚ | Yes | | No | Yes |
| Ex. 5 | ◯ | Yes | | No | Yes |
| Ex. 6 | ⊚ | Yes | | No | — |
| Ex. 7 | ◯ | No | | No | — |
| Ex. 8 | ⊚ | Yes | | No | — |
| Ex. 9 | ⊚ | Yes | | No | — |
| Comp. Ex. 1 | X | No | Yes | — | — |
| Comp. Ex. 2 | ⊚ | Yes | No | — | — |
| Comp. Ex. 3 | ⊚ | No | No | — | — |
| Comp. Ex. 4 | ⊚ | Yes | No | — | — |
| Comp. Ex. 5 | ⊚ | No | Yes | — | — |

| | Evaluation results | | | | | | |
|---|---|---|---|---|---|---|---|
| | | Hardness of | Hardness | | | | |
| | Hardness of first | second | of third | Charging Voltage | Discharge capacity (mAh) | | |
| | particles | particles | particles | (V) | 0.2 C | 3 C | 5 C |
| Ex. 1 | Soft | Hard | — | 4.25 | 3.58 | 3.4 | 3.31 |
| Ex. 2 | Soft | Hard | — | 4.25 | 3.44 | 3.22 | 3.12 |
| Ex. 3 | Soft | Hard | — | 4.25 | 3.34 | 3.09 | 2.98 |
| Ex. 4 | Soft | Hard | Soft | 4.25 | 3.61 | 3.45 | 3.36 |
| Ex. 5 | Soft | Hard | Soft | 4.25 | 3.63 | 3.47 | 3.37 |
| Ex. 6 | Soft | Hard | — | 4.25 | 3.59 | 3.39 | 3.27 |
| Ex. 7 | Soft | Soft | — | 4.25 | 3.58 | 3.39 | 3.28 |
| Ex. 8 | Soft | Hard | — | 4.25 | 3.68 | 3.36 | 3.25 |
| Ex. 9 | Soft | Hard | — | 4.25 | 3.18 | 3.05 | 2.97 |
| Comp. Ex. 1 | Soft | — | — | 4.25 | 0 | 0 | 0 |
| Comp. Ex. 2 | Hard | — | — | 4.25 | 3.49 | 0.74 | 0.36 |
| Comp. Ex. 3 | Soft | — | — | 4.25 | 3.48 | 0.36 | 0.17 |
| Comp. Ex. 4 | Hard | — | — | 3.6 | 3.51 | 2.88 | 2.67 |
| Comp. Ex. 5 | Soft | — | — | 4.25 | 2.93 | 1.05 | 0.48 |

Table 4 shows the energy densities of the non-aqueous electrolyte secondary batteries using the positive electrodes of Example 1 and Comparative Example 4.

TABLE 4

| | Energy density (mWh) | | |
|---|---|---|---|
| | 0.2C | 3C | 5C |
| Ex. 1 | 12.7 | 11.9 | 11.0 |
| Comp. Ex. 4 | 11.65 | 9.07 | 8.16 |

Tables 1 to 4 reveal the following.

In Examples 1 to 9, the adhesion layer was provided in between the positive electrode current collector and the positive electrode active material layer, and that adhesion layer was including the primary or secondary particles harder than the positive electrode current collector (second particles), so it was made possible to embed the primary or secondary particles into the surface of the positive electrode current collector. By this embedment of the particles, the anchor effect was expressed, and thus made possible to suppress delamination of the interface between the positive electrode current collector and the positive electrode active material layer (hereinafter, referred to as “electrode interface”).

In Examples 4 and 5, the adhesion layer was provided in between the positive electrode current collector and the positive electrode active material layer, and that adhesion layer was including the secondary particles harder than the positive electrode current collector (second particles) and the secondary particles softer than the positive electrode current collector (third particles). In Example 4, with respect to the total amount of the secondary particles, the content of the hard secondary particles was 50% by mass, so there were a large number of the secondary particles embedded in the positive current collector, and thus it was made possible to obtain very good adhesiveness. Meanwhile, in Example 5, with respect to the total amount of the secondary particles, the content of the hard secondary particles was 20% by mass, so there were fewer secondary particles embedded in the positive current collector, and as compared to Example 4 the anchor effect tended to decrease, but it was still possible to obtain good adhesiveness.

In Example 7, the adhesion layer was provided in between the positive electrode current collector and the positive electrode active material layer, and that adhesion layer was including the primary particles harder than the positive electrode current collector (second particles), but as compared to Example 1 the adhesiveness tended to decrease. This would be assumed to be due to that in Example 7 an average diameter of the primary particles was small, so the rate of embedded area of the primary particles with respect to the surface of the positive electrode current collector became small, and thus, the anchor effect decreased as compared to Example 1.

In Comparative Example 1, without providing the adhesion layer in between the positive electrode current collector and the positive electrode active material layer, the configuration thereof was one in which the positive electrode active material layer was directly provided on the positive electrode current collector. In addition, the first particles included in the positive electrode active material layer were the secondary particles softer than the positive electrode current collector. Consequently, the first particles were crushed at the time of pressing, and not embedded in the surface of the positive electrode current collector, so it would lead to occurrence of delamination of the electrode interface after the pressing.

In Comparative Example 2, without providing the adhesion layer in between the positive electrode current collector and the positive electrode active material layer, the configuration thereof was one in which the positive electrode active material layer was directly provided on the positive electrode current collector. In addition, the first particles included in the positive electrode active material layer were the particles harder than the positive electrode current collector. Consequently, the anchor effect was expressed, and thus the delamination of the electrode interface was suppressed. However, because the first particles included in the positive electrode active material layer were the primary particles having a large particle diameter, the discharge capacity tended to decrease. In particular, the discharge capacity at 3 C and 5 C tended to decrease significantly.

In Comparative Example 3, without providing the adhesion layer in between the positive electrode current collector and the positive electrode active material layer, the configuration thereof was one in which the positive electrode active material layer was directly provided on the positive electrode current collector. In addition, the first particles included in the positive electrode active material layer were the particles softer than the positive electrode current collector. Consequently, the primary particles (first particles) were not embedded in the surface of the positive electrode current collector, so the anchor effect was not expressed. However, the delamination of the electrode interface was able to be suppressed. This would be assumed to be due to that only the primary particles having a large particle diameter (first particles) were included as the active material in the positive electrode active material layer, and thus even though the content of the binding agent was 4% by mass, the adhesiveness of the electrode interface had been sufficiently retained. However, because the primary particles having a large particle diameter (first particles) were used as the only active material in the positive electrode active material layer, the discharge capacity tended to decrease. In particular, the discharge capacity at 3 C and 5 C tended to decrease significantly.

In Comparative Example 4, without providing the adhesion layer in between the positive electrode current collector and the positive electrode active material layer, the configuration thereof was one in which the positive electrode active material layer was directly provided on the positive electrode current collector. In addition, the secondary particles (first particles) included in the positive electrode active material layer were the particles harder than the positive electrode current collector. Consequently, the anchor effect was expressed, and thus the delamination of the electrode interface was suppressed. However, the first particles included in the positive electrode active material layer were those having LiFePO₄ not containing Mn, as the main component, and thus the energy density tended to decrease.

In Comparative Example 5, without providing the adhesion layer in between the positive electrode current collector and the positive electrode active material layer, the configuration thereof was one in which the positive electrode active material layer was directly provided on the positive electrode current collector. In addition, the positive electrode active material layer was made to include a large amount of the binding agent, and the content thereof was 15% by mass. Consequently, even though the anchor effect was not expressed, the delamination of the electrode interface was able to be suppressed. However, because the positive electrode active material layer was made to include a large amount of the binding agent, the discharge capacity tended to decrease. In particular, the discharge capacity at 3 C and 5 C tended to decrease significantly.

By comparing the foregoing evaluation results of Examples 1 to 9 and Comparative Examples 1 to 5, the following is further revealed.

Comparative Examples 1 and 4: By providing the positive electrode active material particles harder than the positive electrode current collector, as the positive electrode active material particles present at the electrode interface, it is possible to express the anchor effect and suppress the delamination of the electrode interface. In addition, the battery using in the electrode the positive electrode active material particles of LiMnFePO₄ (secondary particles) softer than the positive electrode current collector, is able to improve the energy density as compared to the battery using in the electrode the positive electrode active material particles of LiFePO₄ (secondary particles) harder than the positive electrode current collector.

Comparative Examples 2 and 3: By providing the primary particles having a large particle diameter, as the positive electrode active material particles present at the electrode interface, with or without the expression of the anchor effect, it is possible to suppress the delamination of the electrode interface. However, because the primary particles having a large particle diameter are provided as the whole of the positive electrode active material layer, the discharge capacity tends to decrease.

Comparative Examples 2, 3 and 4: It may be desirable to provide the secondary particles formed by a plurality of the primary particles having a small particle diameter, as the positive electrode active material particles present at the electrode interface, and use as the secondary particles the positive electrode active material particles of LiFePO₄ (secondary particles) harder than the positive electrode current collector. This would make possible to suppress the delamination of the electrode interface and also the decrease of the discharge capacity. In addition, as described above, from the viewpoint of improving the energy density, it may be desirable to use the positive electrode active material particles (LiMnFePO₄ particles) softer than the positive electrode current collector, as the positive electrode active material particles.

### Examples 1 to 3 and Comparative Example 5

The adhesion layer was provided in between the positive electrode current collector and the positive electrode active material layer, and in that adhesion layer, there is used as the positive electrode active material particles the positive electrode active material of LiFePO₄ (secondary particles) harder than the positive electrode current collector. In addition, in the positive electrode active material layer, there is used as the positive electrode active material particles the positive electrode active material of LiMnFePO₄ (secondary particles) softer than the positive electrode current collector. This makes possible to suppress the delamination of the electrode interface without leading to the increase of the content of the binding agent. Thus it is possible to suppress the delamination of the electrode interface, while suppressing the decrease of the discharge capacity.

### Examples 1 to 3

The discharge capacity tends to decrease as the average thickness of the adhesion layer increases. Accordingly, the average thickness of the adhesion layer may desirably be 15 μm or less. The average diameter of the second particles included in the adhesion layer may desirably be less than the average thickness of the adhesion layer, and specifically, 15 μm or less may be desirable.

### Examples 1 and 4

It may be desirable to use, as the positive electrode active material particles in the adhesion layer, both the positive electrode active material of LiFePO₄ (secondary particles) harder than the positive electrode current collector and the positive electrode active material of LiMnFePO₄ (secondary particles) softer than the positive electrode current collector. This would make possible to further improve the energy density.

### Examples 4 and 5

When using as the positive electrode active material particles in the adhesion layer the above-mentioned two positive electrode active materials, the content of the positive electrode active material (secondary particles) harder than the positive electrode current collector may desirably be in the range of 50% by mass or more but less than 100% by mass, and, the content of the positive electrode active material (secondary particles) softer than the positive electrode current collector may desirably be in the range of more than 0% by mass and less than 50% by mass. This would make possible to obtain very good adhesiveness. In addition, as in Example 5, even when only moderately good adhesiveness is obtained, the initial charge-discharge characteristics would tend to show a sufficient value. However, as in Example 4, when very good adhesiveness is obtained, it would tend to be easier to obtain such charge-discharge characteristics over a long period of time.

### Examples 1 and 6

When the primary particles are used in place of the secondary particles as the positive electrode active material in the adhesion layer, it is possible to suppress the delamination of the electrode interface, while almost suppressing the decrease of the discharge capacity. However, an ionic diffusivity within the particle of LiFePO₄ is low, so it is made possible to retain the capacity in the cases with the current amount increased up to 3 C, and 5 C, by refining the primary particles to the size about 0.1 μm. Accordingly, in order to obtain discharge capacity also from the positive electrode active material included in the adhesion layer, it may be desirable to make the primary particles diameter of the positive electrode active material particles included in the adhesion layer as small as about 0.1 μm. Therefore, by comparing the results of Examples 6, 7 and Example 1, it would be suggested that Example 1, in which the primary particles of positive electrode active material included in the adhesion layer are as small as 0.1 μm and the average diameter of the secondary particles are as large as 5 μm, might be having the most desirable configuration.

### Examples 6 and 7

The average diameter of the positive electrode active material particles included in the adhesion layer may desirably be 0.5 μm or more. This would make possible to obtain very good adhesiveness. In addition, as in Example 7, even when only moderately good adhesiveness is obtained, the initial charge-discharge characteristics would tend to show a sufficient value. However, as in Example 6, when very good adhesiveness is obtained, it would tend to be easier to obtain such charge-discharge characteristics over a long period of time.

### Examples 6 and 8

When the primary particles having LiMnFePO₄ as the main component are used in place of the primary particles having LiFePO₄ as the main component, as the positive electrode active material particles included in the adhesion layer, it is possible to suppress the delamination of the electrode interface, while suppressing the decrease of the discharge capacity. In addition, from the viewpoint of improving the energy density, it may be desirable to use the primary particles having LiMnFePO₄ as the main component, as the positive electrode active material particles included in the adhesion layer.

### Examples 6 and 9

When the conductive particles are used in place of the positive electrode active material particles as the second particles included in the adhesion layer, it is possible to suppress the delamination of the electrode interface, while suppressing the decrease of the discharge capacity. However, from the viewpoint of improving the energy density, it may be desirable to use the positive electrode active material particles as the second particles included in the adhesion layer.

### Example 1 and Comparative Example 4

By providing the positive electrode layer in double-layered structure of the adhesion layer and the positive electrode active material layer, using the secondary particles having LiFePO₄ as the main component as material of the adhesion layer, and using the secondary particles having LiFeMnPO₄ as the main component as material of positive electrode active material layer, it is possible to improve the energy density.

Although, the embodiments of the present application have been described above in detail, but the present application is not limited to the above-described embodiments and may be variously modified on the basis of the technical spirits of the present application.

For example, the configurations, the methods, the processes, the shapes, the materials, the numerical values and the like in the foregoing embodiments are merely mentioned for illustrative purpose, and different configurations, methods, processes, shapes, materials, numerical values and the like may be used as appropriate.

Moreover, the configurations, the methods, the processes, the shapes, the materials, the numerical values and the like in the foregoing embodiments may be combined with each other without departing from the spirit of the present application.

In addition, although in the foregoing embodiments the description has been given of examples in which the present application is applied to the lithium-ion battery, the present application is not limited by types of battery, but may be applied to any batteries having a separator. For example, an embodiment of the present application may also be applied to various batteries, such as a nickel-metal hydride battery, a nickel-cadmium battery, a lithium-manganese dioxide battery and a lithium-iron sulfide battery.

Further, although in the foregoing embodiments the description has been given of examples in which the present application is applied to the battery having a spirally wound structure, the structures of the battery is not limited thereto. An embodiment of the present application may also be applied to batteries having a structure with positive and negative electrodes folded, a structure with the electrodes layered, and the like.

Still further, although in the foregoing embodiments the description has been given of examples in which the present application is applied to the batteries having a cylinder shape or a flat shape, the shapes of the battery is not limited thereto. An embodiment of the present application may also be applied to batteries having a coin shape, a button shape, a rectangular shape and the like.

The present application may have the following configurations.

[1] An electrode, including:

a current collector; and

an electrode layer provided on the current collector, including
first particles containing an active material and
second particles harder than the current collector, the second particles being present at least at an interface between the current collector and the electrode layer.
   [2] The electrode according to [1], in which

the second particles present at the interface are provided embedded in the current collector.

[3] The electrode according to any one of [1] or [2], in which

the first particles are softer than the current collector.

[4] The electrode according to any one of [1] to [3], in which

an average diameter of the second particles is in the range of 0.5 μm or more and 15 μm or less.

[5] The electrode according to any one of [1] to [4], in which

the second particles contain an active material.

[6] The electrode according to any one of [1] to [4], in which

the second particles are conductive particles.

[7] The electrode according to [6], in which

an average diameter of the conductive particles is in the range of 0.5 μm or more and 15 μm or less.

[⁸] The electrode according to any one of [1] to [7], further including:

an active material layer including the first particles; and

an adhesion layer including the second particles, the adhesion layer provided in between the current collector and the active material layer.

[9] The electrode according to any one of [1] to [8], in which

the adhesion layer further includes third particles softer than the current collector.

[10] The electrode according to [9], in which

content of the second particles is 50% by mass or more but less than 100% by mass of the total amount of the second particles and the third particles.

[11] The electrode according to any one of [1] to [10], in which

the second particles have a distribution that
increases along the thickness direction of the electrode layer, and
exist with higher density at the interface of the electrode layer than at a side opposite to the interface of the electrode layer.
   [12] The electrode according to according to any one of [1] to [11], in which

the second particles are most abundantly present at the vicinity of the interface of in the electrode layer.

[13] An electrode, including:

a current collector; and

an electrode layer provided on the current collector, including
first particles containing an active material and
second particles harder than the current collector, the second particles provided embedded in the current collector.
   [14] A battery, including:

the electrode according to any one of [1] to [13].

[15] A battery pack, including:

the battery according to [14].

[16] An electronic apparatus including:

the battery according to [14],

the electronic apparatus being configured to receive electricity supply from the battery.

[17] An electric vehicle including:

the battery according to [14];

a converter configured to
receive electricity supply from the battery and
convert the electricity into driving force for vehicle; and

a controller configured to process information on vehicle control on the basis of information on the battery.

[18] An electrical storage apparatus including:

the battery according to [14],

the electrical storage apparatus being configured to provide electricity to an electronic apparatus connected to the battery.

[19] The electrical storage apparatus according to [18], further including:

an electricity information controlling device configured to transmit and receive signals via a network to and from other apparatus,

the electrical storage apparatus being configured to control charge and discharge of the battery on the basis of information that the electricity information controlling device receives.

[20] An electricity system, configured to

receive electricity supply from the battery according to [14]; or

provide electricity from at least one of a power generating device and a power network to the battery.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An electrode, comprising:
a current collector; and
an electrode layer provided on the current collector, including
first particles containing an active material and
second particles harder than the current collector, the second particles being present at least at an interface between the current collector and the electrode layer.

2. The electrode according to claim 1, wherein
the second particles present at the interface are provided embedded in the current collector.

3. The electrode according to claim 1, wherein
the first particles are softer than the current collector.

4. The electrode according to claim 1, wherein
an average diameter of the second particles is in the range of 0.5 μm or more and 15 μm or less.

5. The electrode according to claim 1, wherein
the second particles contain an active material.

6. The electrode according to claim 1, wherein
the second particles are conductive particles.

7. The electrode according to claim 6, wherein
an average diameter of the conductive particles is in the range of 0.5 μm or more and 15 μm or less.

8. The electrode according to claim 1, further comprising:
an active material layer including the first particles; and
an adhesion layer including the second particles, the adhesion layer provided in between the current collector and the active material layer.

9. The electrode according to claim 8, wherein
the adhesion layer further includes third particles softer than the current collector.

10. The electrode according to claim 9, wherein
content of the second particles is 50% by mass or more but less than 100% by mass of the total amount of the second particles and the third particles.

11. The electrode according to claim 1, wherein
the second particles have a distribution that increases along the thickness direction of the electrode layer, and exist with higher density at the interface of the electrode layer than at a side opposite to the interface of the electrode layer.

12. The electrode according to claim 1, wherein
the second particles are most abundantly present at the vicinity of the interface of in the electrode layer.

13. An electrode, comprising:
a current collector; and
an electrode layer provided on the current collector, including
first particles containing an active material and
second particles harder than the current collector, the second particles provided embedded in the current collector.

14. A battery, comprising:
the electrode according to claim 1.

15. A battery pack, comprising:
the battery according to claim 14.

16. An electronic apparatus comprising:
the battery according to claim 14,
the electronic apparatus being configured to receive electricity supply from the battery.

17. An electric vehicle comprising:
the battery according to claim 14;
a converter configured to
receive electricity supply from the battery and
convert the electricity into driving force for vehicle; and
a controller configured to process information on vehicle control on the basis of information on the battery.

18. An electrical storage apparatus comprising:
the battery according to claim 14,
the electrical storage apparatus being configured to provide electricity to an electronic apparatus connected to the battery.

19. The electrical storage apparatus according to claim 18, further comprising:
an electricity information controlling device configured to transmit and receive signals via a network to and from other apparatus,
the electrical storage apparatus being configured to control charge and discharge of the battery on the basis of information that the electricity information controlling device receives.

20. An electricity system, configured to
receive electricity supply from the battery according to claim 14; or
provide electricity from at least one of a power generating device and a power network to the battery.
